(19) United States
(12) Patent Application Publication
(10) Pub. No.: US 2023/0350487 A1
(43) Pub. Date: Nov. 2, 2023

(54) METHOD AND APPARATUS FOR SWITCHING BETWEEN EXTENDED REALITY SIMULATIONS

(71) Applicant: Dell Products, LP, Round Rock, TX (US)

(72) Inventors: Loo Shing Tan, Singapore (SG); Michiel Knoppert, Amsterdam (NL); Gerald Rene Pelissier, Mendham, NJ (US); Martin Sawtell, Singapore (SG)

(73) Assignee: Dell Products, LP, Round Rock, TX (US)

(21) Appl. No.: 17/731,744

(22) Filed: Apr. 28, 2022

(51) Int. Cl. G06F 3/01; G02B 27/01; G06T 19/00

(52) U.S. Cl. CPC G06F 3/011; G02B 27/017; G06T 19/006

(57) ABSTRACT

An information handling system operating a head-mounted display may include a processor, a memory, a PMU, the head-mounted display device further including a display device in the head-mounted display device to present to a user an extended reality image of a surrounding environment, a processor to execute computer readable program code of an extended reality switching system to switch from a first type of extended reality to a second type of extended reality upon detection of an extended reality switching input, and a wireless communication device to receive context data from a remote information management system, the context data including data updating the extended reality images presented to the user based on the extended reality switching input.

### FIELD OF THE DISCLOSURE

The present disclosure generally relates to virtual reality, augmented reality, mixed reality, and other extended reality environments provisioned by, for example, a head mounted display device. The present disclosure more specifically relates to selecting and switching among extended reality environments during use of the head mounted display device.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling needs and requirements vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. Further, the information handling system may be operatively coupled to a virtual reality device such as a head mounted display device that allows a user to view a simulated reality environment.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system with a head-mounted display device according to an embodiment of the present disclosure;

FIG. 2 is a block diagram of a network environment offering several communication protocol options and mobile information handling systems according to an embodiment of the present disclosure;

FIG. 3 is a block diagram illustrating a head-mounted display device operatively coupled to an information handling system according to an embodiment of the present disclosure;

FIG. 4 is a process diagram illustrating a process executed by a head-mounted display device according to an embodiment of the present disclosure; and

FIG. 5 is a flow diagram illustrating a method implemented at a head-mounted display device operatively coupled to an information handling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Head mounted display devices may be wearable around the user's head and/or eyes and have the capability of providing displayed or projected images to a user. Additionally, head-mounted display devices may allow the user to see through those displayed or projected images in, for example, augmented reality (AR). Head mounted display devices may be capable of generating any type of extended reality such as AR, virtual reality (VR), mixed reality (MR), or any other type of extended reality provided by the head-mounted display device and contemplated to exist along a reality-virtuality continuum.

In order to project images within the headset such that they are incorporated within the actual or virtual reality surrounding the headset, a head-mounted display device position engine may execute computer readable program code that determines the location of the head-mounted display device within an environment. In an embodiment, the head-mounted display device position engine may execute computer readable program code defining a simultaneous localization and mapping (SLAM) process. This SLAM process may be employed in order to identify the position of the headset with respect to its surrounding environment, model the surrounding environment as viewed from the perspective of the headset wearer, and render the modeled image and virtual elements in a three-dimensional environment matching or relative to the surrounding real-world environment, among other tasks. Measurements of distances between the headset and landmarks or objects in its surrounding environment may be used in such SLAM processes to identify the position of the headset in its environment. It is appreciated that other types of processes may be implemented by the head-mounted display device position engine that may use data from one or more GPS sensors, accelerometers, and other position sensors. In another example, the head-mounted display device position engine may implement other location-based services (LBS) that define the position of the head-mounted display device. Thus, although the head-mounted display device position engine may be described herein as implementing a SLAM process, these other processes are also contemplated as alternative or additional processes used the define the positional location of the head-mounted display device.

In example embodiments, the head-mounted display device may be used to support immersive training and simulation, collaborative interactions with other users, three-dimensional visualization and review, guided/remote assist applications, and customer engagement and sales enablement, among other uses. For these uses, a user may implement a head-mounted display device operatively coupled to an information handling system executing, for example, a head-mounted display device position engine. In an embodiment, the user may use one or more handheld controllers to provide controller input to the head-mounted display device to affect a visual representation presented to the user via the display device.

Embodiments of the present disclosure describe an extended reality head-mounted display device that allows a user to switch from a first extended reality (e.g., VR, MR, AR) to a second and different extended reality (e.g., VR, MR, AR). This extended reality switching system of the head-mounted display allows for a user to facilitate a variety of tasks including on-site training, on-site simulation, collaborative interactions with other users implementing the head-mounted display device and methods described herein, three-dimensional visualization and review of real-world environments, guided and/or remote assistance applications, customer engagement and sales processes, among others. By allowing a user to switch from a first type of extended reality to a second type of extended reality allows the user to engage in a series of these tasks while on site without leaving the site and while the real-world environment is used during the use of the head-mounted display device.

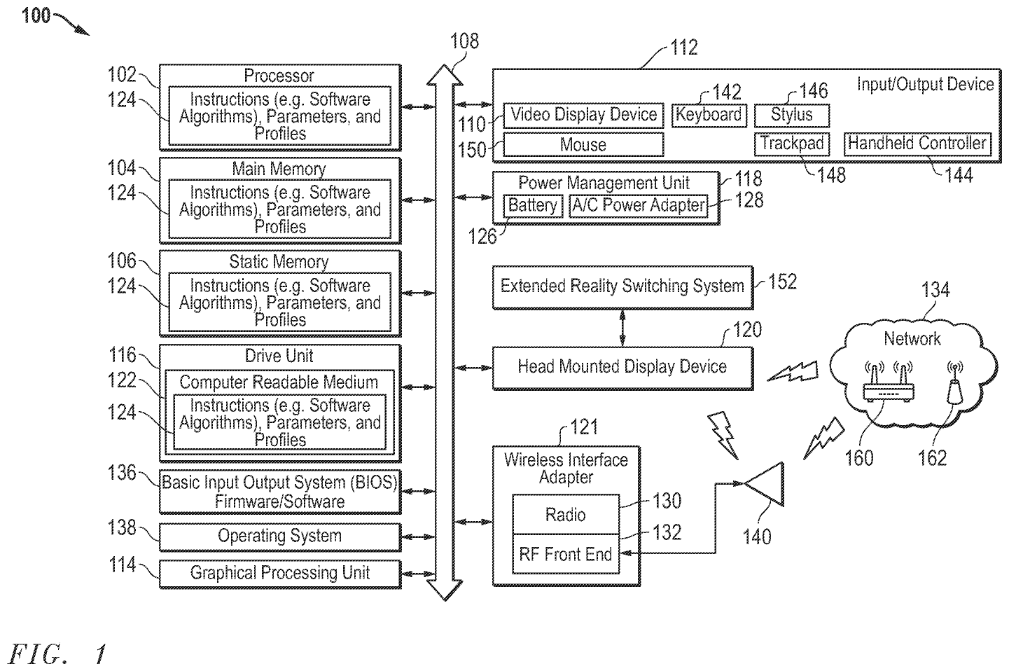

FIG. 1 illustrates an information handling system 100 similar to information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a convertible laptop computer, a tablet computer, a desktop computer, a communications device, an access point (AP), a base station transceiver, a wireless telephone, a land-line telephone, a control system, a camera, a scanner, a facsimile machine, a printer, a personal trusted device, a web appliance, or any other suitable machine capable of executing a set of instructions (sequential or otherwise) that specify actions to be taken by that machine, and can vary in size, shape, performance, price, and functionality.

In a networked deployment, the information handling system 100 may operate in the capacity of a server or as a client computer in a server-client network environment, or as a peer computer system in a peer-to-peer (or distributed) network environment. In a particular embodiment, the computer system 100 can be implemented using electronic devices that provide voice, video, or data communication. For example, an information handling system 100 may be any mobile or other computing device capable of executing a set of instructions (sequential or otherwise) that specify actions to be taken by that machine. In an embodiment, the information handling system 100 may be operatively coupled to a server or other network device as well as with a head-mounted display device 120 and provide data storage resources, processing resources, and/or communication resources to the head-mounted display device 120 as described herein. Further, while a single information handling system 100 is illustrated, the term “system” shall also be taken to include any collection of systems or sub-systems that individually or jointly execute a set, or multiple sets, of instructions to perform one or more computer functions.

The information handling system can include memory (volatile (e.g., random-access memory, etc.), nonvolatile (read-only memory, flash memory etc.) or any combination thereof), one or more processing resources, such as a central processing unit (CPU), a graphics processing unit (GPU), hardware control logic, controller, or any combination thereof. Additional components of the information handling system 100 can include one or more storage devices, one or more communications ports for communicating with external devices, as well as, various input and output (I/O) devices 112, such as a keyboard 142, a mouse 150, a video/graphic display device 110, a stylus 146, a trackpad 148, and a handheld controller 149, or any combination thereof. The information handling system 100 can also include one or more buses 108 operable to transmit data communications between the various hardware components described herein. Portions of an information handling system 100 may themselves be considered information handling systems and some or all of which may be wireless.

Information handling system 100 can include devices or modules that embody one or more of the devices or execute instructions for the one or more systems and modules described above, and operates to perform one or more of the methods described above. The information handling system 100 may execute code instructions 124 via processing resources that may operate on servers or systems, remote data centers, or on-box in individual client information handling systems according to various embodiments herein. In some embodiments, it is understood any or all portions of code instructions 124 may operate on a plurality of information handling systems 100.

The information handling system 100 may include a processor 102 such as a central processing unit (CPU), a graphics processing unit (GPU) 114, a microcontroller, or any other type of processing device that executes code instructions to perform the processes described herein. Any of the processing resources may operate to execute code that is either firmware or software code. Moreover, the information handling system 100 can include memory such as main memory 104, static memory 106, computer readable medium 122 storing instructions 124 of an extended reality switching system 152, and drive unit 116 (volatile (e.g., random-access memory, etc.), nonvolatile (read-only memory, flash memory etc.) or any combination thereof).

As shown, the information handling system 100 may further include a video display device 110. The video display device 110 in an embodiment may function as a liquid crystal display (LCD), an organic light emitting diode (OLED), a flat panel display, or a solid-state display. Additionally, the information handling system 100 may include one or more input/output devices 112 including an alpha numeric input device such as a keyboard 142 and/or a cursor control device, such as a mouse 150, touchpad/trackpad 148, a stylus 146, a handheld controller 149, or a gesture or touch screen input device associated with the video display device 110. In an embodiment, the video display device 110 may provide output to a user remote from the user of the head-mounted display device 120 to, for example, provide real-time training along with the visual training elements provided to the user at the head-mounted display device 120. In an embodiment, the information handling system 100 may be used by a user, remote from the head-mounted display device 120, with the resources of the information handling system 100 providing processing resources, data storage resources, a communication linking the head-mounted display device 120 to a server network, among other functionalities. In another embodiment, the information handling system 100 may be local to the user operating the head-mounted display device 120 with the information handling system 100 operatively coupled to a network 134 via a wireless interface adapter 121.

The network interface device shown as wireless interface adapter 121 can provide connectivity to a network 134, e.g., a wide area network (WAN), a local area network (LAN), wireless local area network (WLAN), a wireless personal area network (WPAN), a wireless wide area network (WWAN), or other network. In an embodiment, the WAN, WWAN, LAN, and WLAN may each include an access point 160 or base station 162 used to operatively couple the information handling system 100 to a network 134. In a specific embodiment, the network 134 may include macro-cellular connections via one or more base stations 162 or a wireless access point 160 (e.g., Wi-Fi or WiGig), or such as through licensed or unlicensed WWAN small cell base stations 162. Connectivity may be via wired or wireless connection. For example, wireless network access points 160 or base stations 162 may be operatively connected to the information handling system 100 and the head mounted display device 120. Wireless interface adapter 121 may include one or more radio frequency (RF) subsystems (e.g., radio 130) with transmitter/receiver circuitry, modem circuitry, one or more antenna front end circuits 125, one or more wireless controller circuits, amplifiers, antennas 140 and other circuitry of the radio 130 such as one or more antenna ports used for wireless communications via multiple radio access technologies (RATs). The radio 130 may communicate with one or more wireless technology protocols. In and embodiment, the radio 130 may contain individual subscriber identity module (SIM) profiles for each technology service provider and their available protocols for any operating subscriber-based radio access technologies such as cellular LTE communications.

In an example embodiment, the wireless interface adapter 121, radio 130, and antenna 140 may provide connectivity to a one or more of the peripheral devices that may include a wireless video display device 110, a wireless keyboard 142, a wireless mouse 150, a wireless headset such as the head-mounted display device 120 and/or a microphone and speaker headset, a wireless stylus 146, a wireless trackpad 148, and a handheld controller 149 among other wireless peripheral devices used as input/output (I/O) devices 112 including any handheld controller 149 associated with the head-mounted display device 120. In an embodiment, the head-mounted display device 120 may include a wireless radio and an antenna to wirelessly couple the head-mounted display device 120 to the information handling system 100 via the antenna 140 and radio 130. In an embodiment, the head-mounted display device 120 may operate with Bluetooth (BT) radio protocols. In other embodiments, the head-mounted display device 120 may operate with Wi-Fi 802.11 radio protocol, 5G NR radio protocols, or other wireless protocols. In an embodiment, an antenna controller operatively coupled to an operating system (OS) 138 may concurrently transceive data to and from the head-mounted display device 120 while a processing device executes an extended reality switching system in order to execute computer readable program code to switch from a first type of extended reality to a second type of extended reality upon detection of extended reality switching input. This processing device may be a processing device on the information handling system 100, at the head-mounted display device 120, or a combination of processors on these devices. In an embodiment, the head-mounted display device 120 may be operatively coupled to the information handling system via a wired connection to a bus 108.

The handheld controller 144 may be a peripheral input/output device 112 used by the user to interact with virtual images presented to the user via the head-mounted display device 120. In an embodiment, the handheld controller 144 may be operatively coupled to the information handling system 100 via a wireless connection using the wireless interface adapter 121 operatively coupled to the bus 108. In this embodiment, input signals from the handheld controller 144 may be relayed to the processor 102 or other processing device and used as input to manipulate an extended reality image presented to the user at the head-mounted display device 120. In an embodiment, the handheld controller 144 may be operatively coupled to the bus 108 via a wired connection and receive this input as described. In another embodiment, the handheld controller 144 may be operatively coupled to the head-mounted display device 120 via a wired or wireless connection. In these examples, the handheld controller 144 may provide input to a processing device at the head-mounted display device 120 to manipulate an extended reality image presented to the user at the head-mounted display device 120.

As described, the wireless interface adapter 121 may include any number of antennas 140 which may include any number of tunable antennas for use with the system and methods disclosed herein. Although FIG. 1 shows a single antenna 140, the present specification contemplates that the number of antennas 140 may include more or less of the number of individual antennas shown in FIG. 1. Additional antenna system modification circuitry (not shown) may also be included with the wireless interface adapter 121 to implement coexistence control measures via an antenna controller as described in various embodiments of the present disclosure.

In some aspects of the present disclosure, the wireless interface adapter 121 may operate two or more wireless links. In an embodiment, the wireless interface adapter 121 may operate a Bluetooth wireless link using a Bluetooth wireless protocol. In an embodiment, the Bluetooth wireless protocol may operate at frequencies between 2.40 to 2.48 GHz. Other Bluetooth operating frequencies are also contemplated in the presented description. In a further aspect, the wireless interface adapter 121 may operate the two or more wireless links with a single, shared communication frequency band such as with the 5G standard relating to unlicensed wireless spectrum for small cell 5G operation or for unlicensed Wi-Fi WLAN operation in an example aspect. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas 140 or antennas 140 may be capable of operating at a variety of frequency bands. In a specific embodiment described herein, the shared, wireless communication band may be transmitted through a plurality of antennas used to operate in an NxN MIMO array configuration where multiple antennas 140 are used to exploit multipath propagation which may be any variable N. For example, N may equal 2, 3, or 4 to be 2×2, 3×3, or 4×4 MIMO operation in some embodiments. Other communication frequency bands, channels, and transception arrangements are contemplated for use with the embodiments of the present disclosure as well and the present specification contemplates the use of a variety of communication frequency bands. In an embodiment, the head-mounted display device 120 also includes an antenna system used to transceive data to and from the information handling system 100 using these wireless communication protocols described herein. Additionally, or alternatively, the antenna system within the head-mounted display device 120 may be used to communicate wirelessly with a remote server at the network 134 via an access point 160 or base station 162.

The wireless interface adapter 121 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth standards, or similar wireless standards may be used. Wireless interface adapter 121 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ˜5 MHz frequency band such as 802.11 a/h/j/n/ac/ax (e.g., center frequencies between 5.170-7.125 GHz). WLAN, for example, may operate at a 2.4 GHz band, 5 GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 1 (NRFR1), NFRF2, bands, and other known bands. Each of these frequencies used to communicate over the network 134 may be based on the radio access network (RAN) standards that implement, for example, eNodeB or gNodeB hardware connected to mobile phone networks (e.g., cellular networks) used to communicate with the information handling system 100. In the example embodiment, the information handling system 100 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end (e.g., antenna front end 132 circuits) of the information handling system 100 may operate on a licensed WWAN wireless radio with authorization for subscriber access to a wireless service provider on a carrier licensed frequency band.

In other aspects, the information handling system 100 operating as a mobile information handling system may operate a plurality of wireless interface adapters 121 for concurrent radio operation in one or more wireless communication bands. The plurality of wireless interface adapters 121 may further share a wireless communication band or operate in nearby wireless communication bands in some embodiments. Further, harmonics and other effects may impact wireless link operation when a plurality of wireless links are operating concurrently as in some of the presently described embodiments.

The wireless interface adapter 121 can represent an add-in card, wireless network interface module that is integrated with a main board of the information handling system or integrated with another wireless network interface capability, or any combination thereof. In an embodiment the wireless interface adapter 121 may include one or more radio frequency subsystems including transmitters and wireless controllers for connecting via a multitude of wireless links. In an example embodiment, an information handling system 100 may have an antenna system transmitter for Bluetooth 5G small cell WWAN, or Wi-Fi WLAN connectivity and one or more additional antenna system transmitters for macro-cellular communication. The RF subsystems and radios 130 include wireless controllers to manage authentication, connectivity, communications, power levels for transmission, buffering, error correction, baseband processing, and other functions of the wireless interface adapter 121.

In an embodiment, the head-mounted display device 120 may include its own extended reality software platform and applications. For example, the head-mounted display device 120 may include a game engine such as Unity® developed by Unity Technologies or Unreal® developed by Epic Games that may be used to help design the extended reality software used to operate the head-mounted display device 120. The head-mounted display device 120 may also include standards such as Open XR® developed by Khronos Group that allows developers to build applications that may work across a variety of head-mounted display devices 320. Development kits such as Vuforia Nvidia Omniverse® developed by Nvidia GTC, ARCore® developed by Google, Qualcomm XR® developed by Qualcomm, may also be executed by the head-mounted display device 120 in order to provide for the development of AR applications and mark less tracking algorithms and computer code to be executed by the head-mounted display device 120. These kits and standards, among others, may be used to develop executable program code and provide content to the user at the head-mounted display device 120.

In an embodiment, the head-mounted display device 120 may include its own wireless interface adapter, radio, antenna front end, and antenna. This may allow the head-mounted display device 120 to communicate with the information handling system 100 or, alternatively, directly to a network housing the remote information management system described herein. As such, this wireless interface adapter, radio, antenna front end, and antenna may allow the head-mounted display device 120 to operate independent of the information handling system 100 if necessary. With the wireless interface adapter, radio, antenna front end, and antenna of the head-mounted display device 120, the head-mounted display device 120 may communicate with the information handling system 100 or the network 134 via an out-of-band (OOB) communication channel. The OOB communication may initially facilitate the communication of the head-mounted display device 120 with the information handling system 100 or some external sensors via, for example, Bluetooth or Wi-Fi communication protocols. In an embodiment, the OOB communication may also be accomplished using those wireless communication protocols described in connection with the operation of the wireless interface adapter 121. In an embodiment, this OOB communication may occur below the basic input/output system (BIOS) 136 or operating system 138 allowing the communication to proceed in the background of other processes being executed by the processor 102 or other processing device such as the GPU 114. This allows the processing resources of the processor 102 or GPU 114 of the information handling system 100 or the processing devices of the head-mounted display device 120 to be conserved for other processing tasks associated with the processing of extended reality images and data associated with the display of those images to the user via the display device of the head-mounted display device 120.

During operation, the information handling system 100 may communicate with the head-mounted display device 120 either via a wired connection or wirelessly as described herein. The operation of the head-mounted display device 120 may not be dependent on the information handling system 100 being in operation, in an embodiment, and the head-mounted display device 120 may be used by the user whether the information handling system 100 is operatively coupled to the head-mounted display device 120 or not. In this embodiment, the head-mounted display device 120 may include the necessary hardware used to, in an embodiment, display an extended reality image of a surrounding environment. This hardware used may vary depending on the type of process used to display the extended reality image to the user. Example process may be grouped into two general categories: inside-out positional tracking processes and outside-in tracking processes. Although, the present specification contemplates the use of outside-in tracking processes, for convenience in description, the present specification describes a head-mounted display device 120 the operates using an inside-out process of tracking the head-mounted display device 120. With the inside-out process of tracking the head-mounted display device 120, the head-mounted display device 120 includes a camera and other sensors used to location the head-mounted display device 120 as it moves within an environment, in an embodiment. In an embodiment, the head-mounted display device 120 may include positional sensors such as a global positioning system (GPS) unit, an inertial measurement unit (IMU), an e-Compass unit, and/or other positional measurement tools such as an accelerometer, a capacitive transducer, a hall effect sensor, a laser doppler vibrometer, a multi-axis displacement transducer, a potentiometer, or a confocal chromatic sensor. Other positional sensors are also contemplated, including a capacitive displacement sensor, an eddy-current sensor, an ultrasonic sensor, a grating sensor, an inductive non-contact position sensor, a linear variable differential transformer, a photodiode array, a piezo-electric transducer, a proximity sensor, a rotary encoder, a seismic displacement pick-up, and a string potentiometer, along with any other positional sensors developed in the future. The positional sensors (e.g., GPS unit, IMU, and/or eCompass unit) in an embodiment may operate to measure location coordinates (x, y, z) of the head-mounted display device 120, as well as orientation (θ), velocity, and/or acceleration. Velocity, acceleration, and trajectory of the head-mounted display device 120 in such an embodiment may be determined by comparing a plurality of measured location coordinates and orientations taken over a known period of time, or may be measured directly by onboard positional sensor such as an accelerometer. Additionally, or alternatively, Wi-Fi triangulation may be used that uses the characteristics of nearby Wi-Fi hotspots and other wireless access points to discover where within an environment the head-mounted display device 120 is located. Additionally, or alternatively, an Internet-of-Things (IoT) device may include sensors that may be detectable by the head-mounted display device 120 and provides data to the head-mounted display device 120 that it is within a physical environment. In an embodiment, a simultaneous localization and mapping (SLAM) engine executing a SLAM process, the IoT devices, and the Wi-Fi hotspot triangulation process may all be used as data inputs to the head mounted display CPU/GPU or the processor 102 to better determine the initial configuration and location of the head-mounted display device 120. In an embodiment, the OOB communication channel may help to communication wirelessly with some of these sensors when determining the location of the head-mounted display device 120. In an embodiment, the head-mounted display device 120 may include an embedded controller that operates this OOB communication link so that this communication may be conducted below the operating system of the head-mounted display device 120. This prevents the head mounted display CPU/GPU from having to receive and compute this data leaving the head mounted display CPU/GPU to conduct, for example, the SLAM computations described herein.

The head-mounted display device 120 may also be capable of capturing video or still images of its surrounding environment, which may include one or more identifiable landmarks. For example, the head-mounted display device 120 may include one or more cameras. These cameras may capture two-dimensional images of the surrounding environment, which may be combined with distance measurements gathered by a plurality of, for example, IR emitters and detectors to generate a three-dimensional image of the surrounding environment. The cameras, in an embodiment, may be, for example, a stereo triangulation camera, an Infrared (IR) camera, a sheet of light triangulation camera, a structured light camera, a time-of-flight camera, an interferometry camera, a coded aperture camera, a RGB digital camera, an infrared digital camera, a telephoto lens digital camera, a fish-eye digital camera, a wide-angle digital camera, a close-focus digital camera, or any other type of camera. The three-dimensional image generated by a processing device (e.g., a processing device in the head-mounted display device 120 or processor 102 and the like) in an embodiment may be used to determine the position and orientation of the head-mounted display device 120 with respect to the one or more landmarks with respect to the physical surroundings as well as any virtual images in a projected extended reality setting on the head-mounted display device 120.

In an embodiment, a processing device either on the head-mounted display device 120 itself or the processor 102 in operative communication with the head-mounted display device 120 may process this received data from these sensors and the camera in order to facilitate the presentation of an extended reality image of a surrounding environment to a user. These images are projected to the user via a display device on the head-mounted display device 120 as described herein. This may be done using, for example a simultaneous localization and mapping (SLAM) process. The SLAM process, in an embodiment, may be employed in order to identify the position of the headset with respect to its surrounding environment, model the surrounding environment as viewed from the perspective of the headset wearer, and render the modeled image in a three-dimensional environment matching the surrounding real-world environment. The surrounding environment may be virtual or some combination of physical and virtual for extended reality. It does this by a processing device (e.g., processor 102 or a processor operatively coupled to the head-mounted display device 120) executing computer readable program code describing an algorithm that concurrently maps a surrounding extended reality environment the head-mounted display device 120 is within and detects the position of the head-mounted display device 120 within that surrounding extended reality environment. IR emitters and sensors housed within or mounted on the exterior surfaces of the head-mounted display device 120 may measure such distances in an embodiment. IR emitters and sensors may be mounted in all directions around the exterior surface of the head-mounted display device 120, in some embodiments. In other embodiments, only portions of the exterior surfaces of the wearable headsets may have infrared emitters and sensors or cameras. For example, the head-mounted display device 120 may emit IR light in a pattern toward the physical landmark, the head-mounted display device 120 may emit IR light, and the head-mounted display device 120 may emit IR light toward the physical landmark. The cameras mounted to the head-mounted display device 120 may then capture an image of each of the IR lights reflecting off the surfaces of the physical landmark. If the surrounding environment further includes other ambient light sources, the cameras will also detect illumination from the physical landmark reflecting such ambient light. For example, if desk lamp and/or floor lamp are turned on, the physical landmark in an embodiment may reflect ambient light generated by the lamps.

The depth of surfaces of nearby objects may be determined by analyzing the way in which the pattern of emitted IR light is distorted as it reaches surfaces of varying distances from the headset. For example, the head-mounted display device 120 may determine the depth of the physical landmark by analyzing the way in which the pattern of emitted IR light is distorted as it reaches the surfaces of physical landmark. Similarly, the head-mounted display device 120 may determine the depth of the physical landmark by analyzing the way in which the pattern of emitted IR light is distorted as it reaches the surfaces of physical landmark, and the head-mounted display device 120 may determine the depth of the physical landmark by analyzing the way in which the pattern of emitted IR light is distorted as it reaches the surfaces of physical landmark. With this data and the other data from the other sensors described herein, the processing device may execute the algorithm defining the SLAM process in order to render to a user via the display device of the head-mounted display device 120 an extended reality image based on a rendered image from the model generated and referenced movement within the surrounding extended reality environment based on movement of the head-mounted display device 120 relative to physical landmarks.

The head-mounted display device 120 may further include an extended reality switching system 152. In an embodiment, the extended reality switching system 152 may, via a processing device, executing computer readable program code to switch from a first type of extended reality to a second type of extended reality upon detection of extended reality switching input. As described herein, the head-mounted display device 120 may be capable of generating and presenting to a user any type of extended reality images including AR, VR, and MR, or any other type of extended reality provided by the head-mounted display device and contemplated to exist along a reality-virtuality continuum. In an embodiment, a user may cause the extended reality switching system 152 to switch from a first type of extended reality to a second type of extended reality by providing input to the head-mounted display device 120. In an embodiment, this input may include a button or switch formed on the head-mounted display device 120 that a user may activate to cause input to be sent to the extended reality switching system 152 to switch from the first type of extended reality to the second type of extended reality. This analog input from the user may allow a user to toggle between, for example, AR, VR, or MR based on the position of the switch or the number times the user actuates the switch. In an embodiment, this switch may be located on a handheld controller or may be presented virtually (e.g., an icon presented visually to a user) to the user via a display device on the head-mounted display device 120 and actionable via use of the handheld controller within the surrounding extended reality environment.

In another embodiment, the extended reality switching system 152 may implement a gesture detection process to determine whether a user is intending to switch from a first type of extended reality to a second type of extended reality. The gesture detection process may include detecting a gesture by a user via the cameras and determining whether that gesture is a triggering gesture (e.g., used as extended reality switching input) within the surrounding extended reality environment used to switch from the first type of extended reality to the second type of extended reality. For example, a user may present, in front of the camera of the head-mounted display device 120 a predetermine hand gesture and, in an example embodiment, the extended reality switching system 152 may execute or have executed a machine learning gesture detection algorithm used to detect a gesture of a user and provide output indicating whether the detected gesture is or is not the triggering gesture. In this embodiment, the operation of the camera or other sensing device may detect a user's gesture by detecting movement of the user's body parts such as, in this example, the user's hand in the physical world or physical environment around the head-mounted display device 120. The camera and other sensors may be used to detect the vector movements of the user's hand and processes those signals using machine learning techniques that can classify those gestures. In an embodiment, the detected gesture movements of a user's hand may be related to the surrounding extended reality environment. During operation and after the camera has detected movement by the user, detected tagged telemetry data may be provided to a machine learning gesture detection algorithm as input. In an embodiment, the machine learning gesture detection algorithm may classify this detected movement of the user to determine if a predetermined triggering gesture is being presented by the user. Where the machine learning gesture detection algorithm determines that a triggering gesture has been detected, the output may be presented to the processor executing the extended reality switching system 152. In an embodiment, the machine learning gesture detection algorithm may be executed at the information handling system 100 at a processor 102 and by the OS 138, in some embodiments, in whole or in part remotely on a server that includes computing resources, or via a processing device on the head-mounted display device 120. In one example embodiment, the machine learning gesture detection algorithm may be remote from the information handling system 100 to be trained remotely. In an embodiment, the machine learning gesture detection algorithm operating at the processor 102 and OS 138 on the information handling system 100 may be a trained module sent to the information handling system 100 from these remote processing service after the machine learning gesture detection algorithm had been trained. During operation and when the trained machine learning gesture detection algorithm provides output indicating that a triggering gesture has been detected, this gesture data may be provided to the processor 102 for the processor 102 to execute a switching from a first type of extended reality to a second type of extended reality.

In another embodiment, the switching conducted by the extended reality switching system 152 may be event-based extended reality switching input. For example, where a training session has been engaged in with the head-mounted display device 120, as the training session is completed, the extended reality switching system 152 may automatically switch from the first type of extended reality to a second type of extended reality. In this embodiment, the completion of the training session may include a flag indicative of the completion and is used as the event-based extended reality switching input. In an embodiment, this event-based extended reality switching input may vary depending on the tasks be completed using the head-mounted display device 120.

Alternatively, or additionally, data descriptive of a detection of the location of the head-mounted display device 120 may be used as extended reality switching input in an embodiment. In this embodiment, the location data may be provided to the extended reality switching system 152 to automatically switch from the first type of extended reality to a second type of extended reality. This may allow a user, as the user moves from one location to another while wearing the head-mounted display device 120, to easily switch from the first type of extended reality to the second type of extended reality without physically activating a hardware button to do so. Using the location data may allow a user in a museum, for example, to traverse throughout the museum while experiencing virtual reality via the head-mounted display device 120 when at a certain location, but automatically switch to, for example, mixed reality as the user is traversing stairs or hallways in order to remain safe while wearing the head-mounted display device 120. As described herein, mixed reality may merge real world images (e.g., obtained via the camera on the head-mounted display device 120) with virtual images allowing the user to see portions of the real world while moving. When the user is stationary, in this example embodiment, the head-mounted display device 120 may produce any type of extended reality environment based on the characteristics of the physical surrounding environment such as a virtual environment. For example, the user may be presented at the head-mounted display device 120 a completely virtual image of the physical environment around the user based on, for example, position/orientation of the head-mounted display device 120 within the physical environment as tracked using a landmark tracking process described herein. In the embodiments herein, however, it is appreciated that a virtual reality may be presented to the user based on data received via other head-mounted display device 120 position/orientation tracking methods.

Additionally, or alternatively, the execution of software at the head-mounted display device 120 may be used as extended reality switching input in an embodiment. In this embodiment, the type of software being or to be executed on the head-mounted display device 120 may indicate whether the extended reality switching system 152 should switch from a first type of extended reality to a second type of extended reality. For example, where a user is actively engaged in the execution of a gaming system, the gaming system may present a virtual reality to the user fully immersing the user in a virtual world. During this execution, the user may choose to cause a videoconference application to be executed and engage in a videoconference with another user that allows for mixed reality images to be shared between the users. The extended reality switching system 152 may detect such changes in the application being executed and switch from the first type of extended reality to the second type of extended reality accordingly. In another embodiment, execution of the software application such as a game or operations-assist software application may reach stages of the software algorithm, for example a stage of a game or a stage or step in a fix, development or assembly process or manufacture, that may be a triggering event. These stages in execution of the software system as a triggering event may comprise an extended reality switching input for the extended reality switching system 152 to switch between types of extended reality operation in various embodiments herein.

The extended reality switching system 152 may provide a user with capability of dynamically switching from viewing a VR simulation, a MR simulation, or an AR simulation to one of the different simulations. VR simulations, generally, include the head-mounted display device 120 providing a complete simulation of a different environment to the user even though that environment presented to the user may resemble real-world environments. With VR simulations, therefore, a complete virtual image is presented to the user via the display device of the head-mounted display device 120 and may provide no real-world images to the user concurrently. With AR simulations, the simulation may include images of objects that reside in the real world with computer-generated perceptual information enhancing those images. In an embodiment, this computer-generated perceptual information may include multiple sensory modalities such as visual, auditory, haptic, somatosensory and even olfactory modalities. The AR simulation may, therefore, include a projection of a real-world environment with information or objects added virtually as an overlay. MR simulations may include a merging of real-world images captured by the camera and virtual, computer-generated images that are presented to the user. In an embodiment, unlike in AR, the user interacting in an MR simulation may interact with the digital-objects presented to the user. As such, it may be helpful to be able to dynamically switch from a first of these extended reality types to another extended reality type when operating the head-mounted display device 120 in various environments.

By way of example, the head-mounted display device 120 of the present specification may be used by an on-site mechanic responsible for repairing a hydro-pump leak. The user may approach the real-world environment, determine that the location is correct, prepare the location for use of the head-mounted display device (e.g., check for dangers that might exist), and put on the head-mounted display device 120 described herein. A digital boundary may be set up initially using the head-mounted display device 120 that prevents the user from being blinded by any type of extended reality while wearing the head-mounted display device 120. The boundary, in an example embodiment, may be drawn or delineated using a handheld controller 144 associated with and operatively coupled to the head-mounted display device 120. Again, the head-mounted display device 120 may be operatively coupled to the information handling system 100 with the information handling system 100 being local or remote to the user and the head-mounted display device 120. The user, in this example, may not be fully trained or otherwise may need to know additional information regarding how to repair the hydro-pump leak.

As the user puts on the head-mounted display device 120 and powers up the head-mounted display device 120, the SLAM process described herein may be initiated that maps the physical environment and prepares a digital image of the physical world. This digital image of the physical world may be presented with augmented reality or mixed reality images during use of the head-mounted display device 120. At this point, the head-mounted display device 120 may present to the user a security or authentication interface for the user to provide login data to access the functionalities of the head-mounted display device 120 as described herein. In an embodiment, these functionalities may include accessing user profiles, work schedule projects, remote assistance tasks, floor and environment maps of the environment (among other environments), and training videos among other data. In an embodiment, this data may be maintained off-site on a remote information management server maintained on the network 134. The head-mounted display device 120 may access this data via a wireless connection via radio and antenna within the head-mounted display device 120. In an embodiment, the radio and antenna may operatively couple the head-mounted display device 120 to a remote server that maintains this data. In another embodiment, the head-mounted display device 120 may be operatively coupled to the information handling system 100 with the wireless interface adapter 121 of the information handling system 100 operatively coupled to a data storage device storing these user profiles, work schedule projects, remote assistance tasks, floor and environment maps of the physical environment (among other environments), and training videos among other data.

With access to this data, the head-mounted display device 120 may determine the user operating the head-mounted display device 120 via the login credentials and access, for example, the user' profile and current work schedule projects. This data may allow the head-mounted display device 120 to access environment-specific data based on the user's work schedule (e.g., indicating where the user is to be at any given time) and the projects to be addressed by the user. Following the example, the user's work schedule may indicate that the hydro-pump at the indicated location is scheduled to be repaired by the user. Based on this additional information, the remote information management server may link the location with accessible floor and environment maps of the environment (among other environments) and training videos related to the environment the user is at currently.

In an embodiment, because the user's task is to repair the hydro-pump and because the user requires additional training, the user may select, on a user display presented to the user on a display device of the head-mounted display device 120, a training session. In an embodiment, this training session may be presented to the user as a virtual reality training session that is fully immersive in the virtual world. As such, the training session may also, based on the floor and environment maps as well as the real-time SLAM data received, create a safety training boundary the user may train within in the current environment. Because the training session is partially based on known floor and environment maps at and around the hydro-pump, the virtual world, in an example embodiment, may mimic the real-world environment. At this point the training session may begin and the user may be trained on not only how to repair a hydro-pump, but also identify the hydro-pump at its specific real-world location using the floor and environment maps.

Once finished with the training session, the head-mounted display device 120 may automatically or otherwise be capable of loading a work order related to the repair of the hydro-pump in the real-world environment. However, for safety reasons, the head-mounted display device 120 may be switched from a VR simulation to one of an AR simulation or MR simulation based on a determination that the user has provided extended reality switching input. Alternatively, the head-mounted display device 120 may be switched from a VR simulation to one of an AR simulation or MR simulation based on an event trigger to be used as extended reality switching input. In the context of this example embodiment, the event-based trigger to be used as extended reality switching input may be an indication that the training session has ended. When this event has been triggered, the extended reality switching system may receive this extended reality switching input and automatically switch from a VR simulation to one of the AR or MR simulations. As such the switching input to the extended reality switching system may be this event-based trigger. The present specification contemplates that other types of event-based triggers may be used based on the context by which the head-mounted display device 120 is used.

In an embodiment, the extended reality switching input may be the activation, by the user, of a switch located on the head-mounted display device 120 that allows the user to switch or toggle from a first type of extended reality (e.g., VR simulation) to a second type of extended reality (e.g., AR simulation or MR simulation). Because either of the AR simulation or MR simulation use the camera on the head-mounted display device 120 or some ability to see the real-world environment, they provide, visually, real-world images to the user via the display device of the head-mounted display device 120 or the ability to see the real-world environment, the user may walk about freely without concern of injury because the user can see, to some extent, real world objects in real-time. In another embodiment, the extended reality switching input may be a gesture presented by the user to switch or toggle from the first type of extended reality (e.g., VR simulation) to the second type of extended reality (e.g., AR simulation or MR simulation). As described, the extended reality switching system 152 may implement a gesture detection process to determine whether a user if intending to switch from a first type of extended reality to a second type of extended reality. The gesture detection process may include detecting a gesture by a user via the cameras and determining whether that gesture is a triggering gesture used as extended reality switching input for the extended reality switching system 152 to switch from the first type of extended reality to the second type of extended reality. For example, a user may present, in front of the camera of the head-mounted display device 120 a predetermine hand gesture and, in an example embodiment, the extended reality switching system 152 may execute or have executed a machine learning gesture detection algorithm used to detect a gesture of a user and provide output indicating whether the detected gesture is or is not the triggering gesture as described herein. For example, a wave, finger or hand swipe, or any other gesture may be detected and recognized by the camera or head-mounted display device 120 when referenced with a database of gestures or determined as a gesture via a machine learning gesture detection algorithm.

After the head-mounted display device 120 has switched from the first type of extended reality to the second type of extended reality, the user may proceed with the real-world repair of the hydro-pump. In an embodiment, because the head-mounted display device 120 is operatively coupled to a remote information management system remote from the user and head-mounted display device 120, a supervisor or other managerial member may view and participate with the user in conducting the repair of the hydro-pump. For example, a managing user operating another head-mounted display device 120 may be presented, in real-time, similar VR, AR, or MR images presented to the user at the hydro-pump and may provide additional feedback either during the training session or the actual repair of the hydro-pump. The managing user may also, when the repair is done, indicate via the user's schedule that the repair had been satisfactorily conducted thereby removing the task from the user's schedule.

In an embodiment, the user's experience may be recorded. This recording may include, in an embodiment, the user's operation of the head-mounted display device 120 from the moment the user had activated the training session to the moment the managerial user had signed off on the completed task of repairing the hydro-pump. In an embodiment, the recording may be maintained on a server associated with the remote information management system for future use. In an embodiment, this recording may be used for future training purposes should the hydro-pump need additional repairs. In an embodiment, this recording may be used for record keeping purposes such as during a review process confirming the repair done on the hydro-pump was completed competently.

It is appreciated that the head-mounted display device 120 may be used for additional purposes where switching from a first type of extended reality to a second type of extended reality provides additional benefits to a user or users. For example, the user may engage in a collaboration session with other users of additional head-mounted display devices 120 that are remote, local, or a combination thereof. This collaboration session may include some or all of the users switching from a first type of extended reality to a second type of extended reality so that real-world objects such as a whiteboard or office space may be selectively viewable to the users. This may be helpful in, for example, designing a workspace where one or more users wearing the head-mounted display devices 120 provide real-world and real-time views of a space to be designed to remote users who also can switch from the first type of extended reality to the second type of extended reality as they please in order to get different viewpoints as to how to design the space in the real world. Other example embodiments include sales meetings where a salesman providing solar panel installations, for example, can interact with a homeowner via the head-mounted display device 120 so that the homeowner may visualize a solar panel installation via a VR simulation and selectively view a solar panel installation on the user's own home via an AR simulation or MR simulation. In an embodiment, an event-based trigger originating from the remote head-mounted display device may be used as extended reality switching input to the extended reality switching system 152 to automatically switch the user's head-mounted display device from display a VR simulation to one or more of an AR simulation or MR simulation. This may increase sales of the solar panels by causing, via the salesman's event-driven sales pitch, the homeowner/user to see visually at one point a VR simulation of the sales pitch, and at another point show via AR simulation or MR simulation what the solar panels can do and will look like when installed. Indeed, the head-mounted display device 120 with the extended reality switching system described herein may allow any user to collaborate with any other user for a variety of reasons.

The information handling system 100 can include a set of instructions 124 that can be executed to cause the computer system to perform any one or more of the methods or computer-based functions disclosed herein. For example, instructions 124 may execute an extended reality switching system 152, a machine learning gesture detection algorithm, various software applications, software agents, or other aspects or components. Various software modules comprising application instructions 124 may be coordinated by an operating system (OS) 138, and/or via an application programming interface (API). An example OS 138 may include Windows®, Android®, and other OS types known in the art. Example APIs may include Win 32, Core Java API, or Android APIs.

The disk drive unit 116 and may include a computer-readable medium 122 in which one or more sets of instructions 124 such as software can be embedded to be executed by the processor 102 or other processing devices such as a GPU 114 to perform the processes described herein. Similarly, main memory 104 and static memory 106 may also contain a computer-readable medium for storage of one or more sets of instructions, parameters, or profiles 124 described herein. The disk drive unit 116 or static memory 106 also contain space for data storage. Further, the instructions 124 may embody one or more of the methods or logic as described herein. In a particular embodiment, the instructions, parameters, and profiles 124 may reside completely, or at least partially, within the main memory 104, the static memory 106, and/or within the disk drive 116 during execution by the processor 102 or GPU 114 of information handling system 100. The main memory 104, GPU 114, and the processor 102 also may include computer-readable media.

Main memory 104 or other memory of the embodiments described herein may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The extended reality switching system 152 and machine learning gesture detection algorithm may be stored in static memory 106 or on the drive unit 116 that may include access to a computer-readable medium 122 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In ab embodiment, the information handling system 100 may further include a power management unit (PMU) 118 (a.k.a. a power supply unit (PSU)). The PMU 118 may manage the power provided to the components of the information handling system 100 such as the processor 102, a cooling system, one or more drive units 116, a graphical processing unit (GPU), a video/graphic display device 110 or other input/output devices 112 such as the stylus 146, and other components that may require power when a power button has been actuated by a user. In an embodiment, the PMU 118 may monitor power levels and be electrically coupled, either wired or wirelessly, to the information handling system 100 to provide this power and coupled to bus 108 to provide or receive data or instructions. The PMU 118 may regulate power from a power source such as a battery 126 or A/C power adapter 128. In an embodiment, the battery 126 may be charged via the A/C power adapter 128 and provide power to the components of the information handling system 100 via a wired connections as applicable, or when A/C power from the A/C power adapter 128 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include software, including firmware embedded at a device, such as an Intel® Core class processor, ARM® brand processors, Qualcomm® Snapdragon processors, or other processors and chipsets, or other such device, or software capable of operating a relevant environment of the information handling system. The system, device, controller, or module can also include a combination of the foregoing examples of hardware or software. Note that an information handling system can include an integrated circuit or a board-level product having portions thereof that can also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another can communicate directly or indirectly through one or more intermediaries.

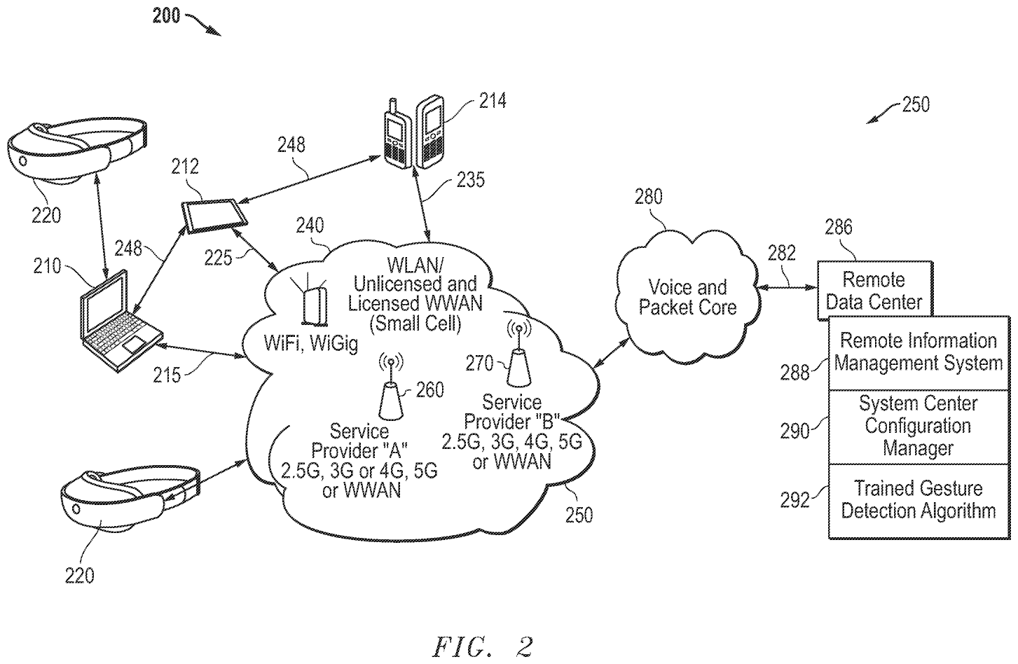

FIG. 2 illustrates a network 200 that can include one or more information handling systems 210, 212, 214. Additionally, one or more head-mounted display devices 220 may be operatively coupled, wired or wirelessly, to the network 200 either directly or indirectly via the one or more information handling systems 210, 212, 214. The information handling systems 210, 212, 214 and head-mounted display devices 220 shown in FIG. 2 may be similar to the information handling system 100 and head-mounted display devices 220 described in connection with FIG. 1, respectively. In a particular embodiment, network 200 includes networked mobile information handling systems 210, 212, 214, head-mounted display devices 220, wireless network access points, and multiple wireless connection link options. A variety of additional computing resources of network 200 may include client mobile information handling systems, data processing servers, network storage devices, local and wide area networks, or other resources as needed or desired. As partially depicted, information handling systems 210, 212, 214 may be a laptop computer, tablet computer, 360-degree convertible systems, wearable computing devices, or a smart phone device. These information handling systems 210, 212, 214, may access a wireless local network 240, or they may access a macro-cellular network 250. For example, the wireless local network 240 may be the wireless local area network (WLAN), a wireless personal area network (WPAN), or a wireless wide area network (WWAN). In an example embodiment, LTE-LAA WWAN may operate with a small-cell WWAN wireless access point option.

Since WPAN or Wi-Fi Direct Connection 248 and WWAN networks can functionally operate similar to WLANs, they may be considered as wireless local area networks (WLANs) for purposes herein. Components of a WLAN may be connected by wireline or Ethernet connections to a wider external network such as a voice and packet core 280. For example, wireless network access points (e.g., 160 FIG. 1) or base stations (e.g., 162, FIG. 1) may be connected to a wireless network controller and an Ethernet switch. Wireless communications across wireless local network 240 may be via standard protocols such as IEEE 802.11 Wi-Fi, IEEE 802.11ad WiGig, IEEE 802.15 WPAN, IEEE 802.11ax-2021, (e.g., Wi-Fi 6 and 6E, 6 GHz technologies), or emerging 5G small cell WWAN communications such as gNodeB, eNodeB, or similar wireless network protocols and access points. Alternatively, other available wireless links within network 200 may include macro-cellular connections 250 via one or more service providers 260 and 270. As described herein, a plurality of antennas may be operatively coupled to any of the macro-cellular connections 250 via one or more service providers 260 and 270 or to the wireless local area networks (WLANs) selectively based on the SAR data, RSSI data, configuration data, system operation and connection metrics, peripheral telemetry data, and antenna mounting locations (e.g., spatial locations of antennas within the information handling system) associated with each information handling systems 210, 212, 214 as described herein. Service provider macro-cellular connections may include 2G standards such as GSM, 2.5G standards such as GSM EDGE and GPRS, 3G standards such as W-CDMA/UMTS and CDMA 2000, 4G standards, or emerging 5G standards including WiMAX, LTE, and LTE Advanced, LTE-LAA, small cell WWAN, and the like.

Wireless local network 240 and macro-cellular network 250 may include a variety of licensed, unlicensed or shared communication frequency bands as well as a variety of wireless protocol technologies ranging from those operating in macrocells, small cells, picocells, or femtocells. As described herein, utilization of RF communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ˜5 MHz frequency band such as 802.11 a/h/j/n/ac/ax (e.g., center frequencies between 5.170-7.125 GHz). WLAN, for example, may operate at a 2.4 GHz band, 5 GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 1 (NRFR1), NFRF2, bands, and other known bands. Each of these frequencies used to communicate over the network 240, 250 may be based on the radio access network (RAN) standards that implement, for example, eNodeB or gNodeB hardware connected to mobile phone networks (e.g., cellular networks) used to communicate with the information handling systems 210, 212, 214 and head-mounted display devices 220. In the example embodiment, mobile one or more information handling systems 210, 220, 230 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, an WWAN RF front end of the information handling systems 210, 212, 214 may operate on a licensed WWAN wireless radio with authorization for subscriber access to a wireless service provider on a carrier licensed frequency band. WLAN such as Wi-Fi (e.g., Wi-Fi 6) may be unlicensed.

In some embodiments, a networked mobile information handling system 210, 212, 214 and/or head-mounted display devices 220 may have a plurality of wireless network interface systems capable of transmitting simultaneously within a shared communication frequency band. That communication within a shared communication frequency band may be sourced from different protocols on parallel wireless network interface systems or from a single wireless network interface system capable of transmitting and receiving from multiple protocols. Similarly, a single antenna or the plurality of antennas in each information handling systems 210, 212, 214 or head-mounted display devices 220 may be used on each of the wireless communication devices such as according to embodiments herein and may be suited to plural RF bands. Example competing protocols may be local wireless network access protocols such as Wi-Fi/WLAN, WiGig, and small cell WWAN in an unlicensed, shared communication frequency band. Example communication frequency bands may include unlicensed 5 GHz frequency bands or 3.5 GHz conditional shared communication frequency bands under FCC Part 96. Wi-Fi ISM frequency bands may be subject to sharing include 2.4 GHz, 60 GHz, 900 MHz or similar bands as understood by those of skill in the art. Within local portion of wireless network 250 access points for Wi-Fi or WiGig as well as small cell WWAN connectivity may be available in emerging 5G technology. This may create situations where a plurality of antenna systems are operating on a mobile information handling system 210, 212, 214 via concurrent communication wireless links on both WLAN and WWAN radios and antenna systems. In some embodiments, concurrent wireless links may operate within the same, adjacent, or otherwise interfering communication frequency bands and may be required to utilize spaced antennas. The antenna may be a transmitting antenna that includes high-band, medium-band, low-band, and unlicensed band transmitting antennas in embodiments herein. The antenna may cooperate with other antennas in a N×N MIMO array configuration according to the embodiments described herein. Alternatively, embodiments may include a single transceiving antennas capable of receiving and transmitting, and/or more than one transceiving antennas. Each of the antennas included in the information handling systems 210, 212, 214 and/or head-mounted display devices 220 in an embodiment may be subject to the FCC regulations on specific absorption rate (SAR).

The voice and packet core network 280 shown in FIG. 2 may contain externally accessible computing resources and connect to a remote data center 286. The voice and packet core network 280 may contain multiple intermediate web servers or other locations with accessible data (not shown). The voice and packet core network 280 may also connect to other wireless networks similar to 240 or 250 and additional mobile information handling systems such as 210, 212, 214, head-mounted display devices 220, or similar connected to those additional wireless networks. Connection 282 between the wireless network 240 and remote data center 286 or connection to other additional wireless networks may be via Ethernet or another similar connection to the world-wide-web, a WAN, a LAN, another WLAN, or other network structure. Such a connection 282 may be made via a WLAN access point/Ethernet switch to the external network and be a backhaul connection. The access point may be connected to one or more wireless access points in the WLAN before connecting directly to a mobile information handling system or may connect directly to one or more information handling systems 210, 212, 214 and/or head-mounted display devices 220. Alternatively, mobile information handling systems 210, 212, 214 and or head-mounted display devices 220 may connect to the external network via base station locations at service providers such as 260 and 270. These service provider locations may be network connected via backhaul connectivity through the voice and packet core network 280.

Remote data centers 286 may include web servers or resources within a cloud environment that operate via the voice and packet core 280 or other wider internet connectivity. For example, remote data centers can include additional information handling systems, data processing servers, network storage devices, local and wide area networks, or other resources as needed or desired. In an embodiment, the remote data center 286 may include a remote information management system 288 that store the user profiles, work schedule projects, remote assistance tasks, floor and environment maps of the physical environment (among other environments), and training videos among other data. As described herein, this data may be used by each of the head-mounted display devices 220 to help generate the VR simulations, AR simulations, and MR simulations as described herein.

Having such remote capabilities may permit fewer resources to be maintained at the mobile information handling systems 210, 212, 214 or head-mounted display devices 220 allowing streamlining and efficiency within those devices. In an embodiment, the remote information management system 288 may be part of a 5G multi-edge compute server placed at an edge location on the network 200 for access by the information handling systems 210, 212, 214 and/or head-mounted display devices 220. In an embodiment, the remote data center 286 permits fewer resources to be maintained in other parts of network 200. In an example embodiment, processing resources on the remote data center 286 may requests from head-mounted display devices 220 to engage in training and extended reality simulations. Although an information handling system 210, 212, 214 may be used to process some of the data used to provide a VR, AR, and/or MR simulation to the displays of the head-mounted display devices 220, the remote data center 286 may facilitate the remote information management system 288 to perform those tasks described herein such as accessing user profiles, developing and providing work schedule projects, remote assistance tasks, provisioning of floor and environment maps of the environment (among other environments), provisioning training videos, facilitating any collaboration tasks such as relaying voice and data from one user of a head-mounted display device 220 to another user of another head-mounted display device 220, and recording the audio/video of the head-mounted display devices 220 during operation, among other tasks described herein. In an embodiment, the remote data center 286 may further maintain a system center configuration manager (SCCM) 290. The SCCM 290 may push configuration policies to other manageability methods down the participating devices including the head-mounted display devices 220 and any information handling systems 210, 212, 214 associated, if at all, with the head-mounted display devices 220. These configuration policies may include device specific configuration policies and manageability methods and may include device identification data such that the SCCM 290 may know which of the configuration policies to provide to the individual head-mounted display device 220.

In this embodiment, a trained gesture detection algorithm 292 may be sent back to the mobile information handling systems 210, 220, and 230 and/or head-mounted display devices 220. In an example embodiment, the mobile information handling systems 210, 220, and 230 or head-mounted display devices 220 may communicate with a backend server such as the remote data center 286 and its remote information management system 288 and SCCM 290 or other server on at least one radio access technology (RAT) network to execute other remote applications or access remote data, websites, or communications.

Although communication links 215, 225, and 235 are shown connecting wireless adapters of information handling systems 210, 212, 214 to wireless networks 240 or 250, a variety of wireless links are contemplated. Wireless communication may link through a wireless access point (e.g., Wi-Fi), through unlicensed WWAN small cell base stations such as in network 240 or through a service provider tower and base stations such as that shown with service provider A 260 or service provider B 270 and in network 250. In other aspects, mobile information handling systems 210, 212, 214 may communicate intra-device via inter-communication links 248 when one or more of the information handling systems 210, 212, 214 are set to act as an access point or even potentially an WWAN connection via small cell communication on licensed or unlicensed WWAN connections. For example, one of mobile information handling systems 210, 212, 214 may serve as a Wi-Fi hotspot in an embodiment. Concurrent wireless links to information handling systems 210, 212, 214 may be connected via any access points including other mobile information handling systems as illustrated in FIG. 2.

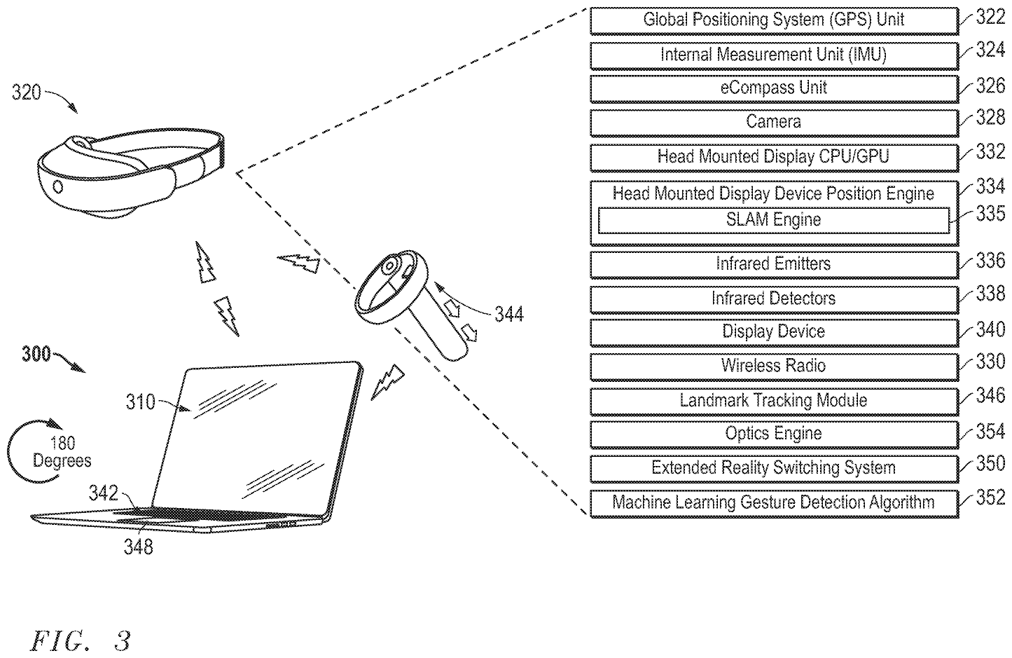

FIG. 3 is a block diagram illustrating a head-mounted display device 320 operatively coupled to an information handling system 300 according to an embodiment of the present disclosure. As described herein, the head-mounted display device 320 may be communicatively coupled to the information handling system 300 either via a wired or wireless connection. In an embodiment, the information handling system 300 may be remote to the user operating the head-mounted display device 320 or may be local with the information handling system 300 acting as an intermediary device to a remote information management system on a network as described herein.

As partially depicted, information handling system 300 may be a laptop computer such as a 360-degree convertible system. The information handling system 300 may include, as described herein, a keyboard 342, a mouse (not shown), a video/graphic display 310, a stylus (not shown), a trackpad 348, a handheld controller 344, or any combination thereof. These input devices may be used to communicate with the head-mounted display device 320 and provide output to the user via, for example, a visual representation on the video/graphic display 310 of what the user sees when operating the head-mounted display device 320. For example, the handheld controller 344 may be operatively coupled wirelessly or by wire to the head-mounted display device 320, to the information handling system 300, or both.

As described herein, the head-mounted display device 320 may include any number of sensors used to determine the position of the head-mounted display device 320 within an environment by executing, with a processor, the head mounted display device positioning engine 334. For example, the head-mounted display device 320 in an embodiment may include positional sensors such as a global positioning system (GPS) unit 322, an inertial measurement unit (IMU) 324, an e-Compass unit 326, and/or other positional measurement tools such as an accelerometer, a capacitive transducer, a hall effect sensor, a laser doppler vibrometer, a multi-axis displacement transducer, a potentiometer, or a confocal chromatic sensor. Other positional sensors are also contemplated, including a capacitive displacement sensor, an eddy-current sensor, an ultrasonic sensor, a grating sensor, an inductive non-contact position sensor, a linear variable differential transformer, a photodiode array, a piezo-electric transducer, a proximity sensor, a rotary encoder, a seismic displacement pick-up, and a string potentiometer, along with any other positional sensors developed in the future. The positional sensors (e.g., GPS unit 322, IMU 324, and/or eCompass unit 326) in an embodiment may operate to measure location coordinates (x, y, z) of the head-mounted display device 320, as well as orientation (θ), velocity, and/or acceleration. Velocity, acceleration, and trajectory of the head-mounted display device 320 in such an embodiment may be determined by comparing a plurality of measured location coordinates and orientations taken over a known period of time, or may be measured directly by onboard positional sensor such as an accelerometer. Again, a SLAM process may be executed by a SLAM engine 335, in an embodiment, in order to identify the position of the headset with respect to its surrounding physical environment, model the surrounding physical environment as viewed from the perspective of the headset wearer, and render the modeled image and virtual elements in a three-dimensional extended reality environment matching or relative to the surrounding real-world environment, among other tasks.

In another embodiment, the head-mounted display device 320 may include or interact with other types of positional devices that provide data to the head-mounted display device 320 to determine the location of the head-mounted display device 320 within a physical environment. For example, an Internet-of-Things (IoT) device may include sensors that may be detectable by the head-mounted display device 320 that provides data to the head-mounted display device 320 that it is within a physical environment. This may include tags, transponders, or other location tags that can be used to triangulate the location of the head-mounted display device 320 within the physical environment. Other sensors such as IR detectors 338 and IR emitters 336, for example, either on the head-mounted display device 320 (e.g., inward-out location detection) or located within the physical environment (e.g., outward-in location detection), that is used to triangulate the location of the head-mounted display device 320 within the physical environment.

The head-mounted display device 320 may also be capable of capturing video or still images of its surrounding physical environment, which may include one or more identifiable landmarks. For example, the head-mounted display device 320 may include a head mounted display camera 328. The camera 328 may capture a two-dimensional image of the surrounding physical environment, which may be combined with distance measurements gathered by a plurality of IR emitters 336 and IR detectors 338 to generate a three-dimensional image of the surrounding environment as a reference for extended reality applications. The camera 328 in an embodiment may be, for example, a stereo triangulation camera, an Infrared (IR) camera, a sheet of light triangulation camera, a structured light camera, a time-of-flight camera, an interferometry camera, a coded aperture camera, a RGB digital camera, an infrared digital camera, a telephoto lens digital camera, a fish-eye digital camera, a wide-angle digital camera, a close-focus digital camera, or any other type of camera. The three-dimensional image captured by a three-dimensional camera 328 in an embodiment may be used to determine the position and orientation of the head-mounted display device 320 with respect to the one or more landmarks viewable within the physical environment for reference of motion in an AR, VR, or MR environment presented to a user of the head-mounted display device 320.

The head-mounted display device 320 in an embodiment may further include a head mounted display CPU/GPU 332 or other processor, which may execute instructions to provide images to the user via the display device 340 of the head-mounted display device 320. Such instructions executed by the head mounted display CPU/GPU 332 or other processor in an embodiment may include those instructions used to create the VR simulation, the AR simulation, and/or the MR simulation by projecting images to the user whether those images are superimposed over real-world images captured by the camera 328 or not.

The head mounted display CPU/GPU 332 or other processor may also transmit an image of the surrounding environment captured by the camera 328, the measured position (x, y, z), orientation (θ), velocity, and/or acceleration of the head-mounted display device 320 to the wirelessly connected laptop or desktop information handling system 300 via a network adapter and a wireless radio 330 in an embodiment. The head mounted display CPU/GPU 332 or other processor may also receive SLAM frames indicating the positions of the head-mounted display device 320 and one or more identified landmarks in the surrounding environment from the remotely connected laptop or desktop information handling system 300 via the network adapter.

The head mounted display CPU/GPU 332 or other processor in an such an embodiment may determine the position/orientation of identified landmarks with respect to the head-mounted display device 320 through analysis of the positional information measured in the image captured by the camera 328 in combination with an identification by a landmark tracking module 346 of the one or more landmarks. In some embodiments, such positional/orientation information may be received at the head mounted display CPU/GPU 332 or other processor from the remotely located laptop or desktop information handling system 300 via a network adapter as described herein.

The head-mounted display device 320 in an embodiment may further include one or more subsystems capable of identifying one or more landmarks within three-dimensional image information as described herein. For example, the head-mounted display device 320 may include a landmark tracking module 346. The landmark tracking module 346 in an embodiment may access the three-dimensional image information of one or more nearby landmarks captured by the head-mounted display device 320. In some embodiments, the landmark tracking module 346 may identify the physical boundaries of one or more potential landmarks within the three-dimensional image captured by the camera 328. Once the physical boundaries of the landmarks are identified by the landmark tracking module 346 in an embodiment, the distance between these identified items and the head-mounted display device 320 may be determined.

A plurality of IR emitters 336 may be mounted along the exterior of the head-mounted display device 320 in an embodiment. Each IR emitters 336 (e.g., an infrared light emitting diode) in an embodiment may operate to emit infrared (IR) light toward the environment surrounding the head-mounted display device 320. In some embodiments, the light emitted from each IR emitter 336 may be patterned, and each IR emitter 336 may emit the same pattern, or different IR emitters 336 may emit different patterns. The intensity of light emitted from each of the IR emitters 336 in an embodiment may be controlled by the head mounted display CPU/GPU 332, a controller (not shown), or an integrated circuit or chip (not shown) executing firmware instructions of the IR emitters 336. Such firmware may also identify the position of each IR emitter 336 along the exterior of the head-mounted display device 320 (e.g., position with respect to field of view of headset).

The head-mounted display device 320 may further include one or IR detectors 338 capable of detecting infrared light emitted from the plurality of IR emitters 336 reflecting off the surfaces of landmarks or objects within the environment surrounding the head-mounted display device 320. IR detectors 338, in an embodiment, may be composed of IR light emitting detector (LED) or detector capable of generating an electrical current based on received or detected infrared light. Electrical currents generated by the plurality of IR detectors 338 in an embodiment may be used to determine a length of time during which light emitted from an IR emitter 336 traveled toward an object in the environment surrounding the head-mounted display device 320, then travelled back toward the IR detector 338 upon reflection.

The head head-mounted display device 320 may further include one or more subsystems capable of mapping the positions/orientations of the head-mounted display device 320 and one or more identified landmarks within a virtual three-dimensional environment in an embodiment. For example, the head-mounted display device 320 may include a head mounted display (HIVID) device position engine 334 that may include, in an embodiment, a simultaneous localization and mapping (SLAM) engine 335. The SLAM engine 335, in an embodiment, may access the position/orientation information for the one or more landmarks with respect to the head-mounted display device 320 generated or received by the head mounted display CPU/GPU 332, and use this information to generate a three-dimensional virtual map of head-mounted display device 320 and its surrounding environment, including the one or more identified landmarks. In other embodiments, the head mounted display CPU/GPU 332 may receive one or more SLAM frames including three-dimensional virtual maps of the head-mounted display device 320 and its surrounding environment from the remotely located laptop or desktop information handling system 300 via a network adapter.

In an embodiment, one or more subsystems capable of rendering an image of the surrounding environment from the perspective of the head-mounted display device 320 may also be included onboard the head-mounted display device 320. For example, the head-mounted display device 320 may include an optics engine 354, which may access the three-dimensional virtual map generated by the SLAM engine 335 or received from the remotely located information handling system 300 in an embodiment. The optics engine 354 in an embodiment may render a three-dimensional image of the surrounding environment including the identified one or more landmarks based on the location/orientation of the landmarks with respect to the head-mounted display device 320 within the virtual map, as with a VR simulation. In other embodiments, the optics engine 354 may render a three-dimensional image of an object projected to appear as if it is incorporated within the environment surrounding the head-mounted display device 320, as with an AR simulation or even a MR simulation.

The head-mounted display device 320 in an embodiment may further include one or more subsystems capable of and displaying the rendered image of the surrounding environment within the head-mounted display device 320. For example, the head-mounted display device 320 may include a head mounted display device 340, capable of displaying the image (e.g., VR image, AR image, or MR image) rendered by the optics engine 354.

The head-mounted display device 320 in an embodiment may further include an extended reality switching system 350. The extended reality switching system 350 may be, in an example embodiment, computer readable program code that, when executed by the head mounted display CPU/GPU 332, switches from a first type of extended reality (e.g., VR simulation, AR simulation, or MR simulation) to a second type of extended reality (e.g., VR simulation, AR simulation, or MR simulation) upon detection of extended reality switching input. As described herein, the head-mounted display device 320 may be capable of generating and presenting to a user any type of extended reality images including AR, VR, and MR, or any other type of extended reality provided by the head-mounted display device and contemplated to exist along a reality-virtuality continuum. In an embodiment, a user may cause the extended reality switching system 350 to switch from a first type of extended reality to a second type of extended reality by providing input to the head-mounted display device 320. In an embodiment, this input may include a button or switch formed on the head-mounted display device 320 or on the handheld controller 344 that a user may activate to cause input (e.g., extended reality switching input) to be sent to the extended reality switching system 350 to switch from the first type of extended reality to the second type of extended reality. This analog input from the user may allow a user to toggle between, for example, AR, VR, or MR based on the position of the switch or a plurality of times the user actuates the switch.

In another embodiment, the extended reality switching system 350 may implement a gesture detection process to determine whether a user is intending to switch from a first type of extended reality to a second type of extended reality. The gesture detection process may include detecting a gesture by a user via the cameras and determining whether that gesture is a triggering gesture used as extended reality switching input by the extended reality switching system 350 to switch from the first type of extended reality to the second type of extended reality. For example, a user may present, in front of the camera of the head-mounted display device 320 a predetermine hand gesture and, in an example embodiment, the extended reality switching system 350 may execute or have executed a machine learning gesture detection algorithm 352 used to detect a gesture of a user and provide output indicating whether the detected gesture is or is not the triggering gesture. In this embodiment, the operation of the camera 328 or other sensing device may detect a user's gesture via execution of the machine learning gesture detection algorithm 352 by a head mounted display CPU/GPU 332 by detecting movement of the user's body parts such as, in this example, the user's hand. The camera 328 and other sensors may be used to detect the vector movements of the user's hand and processes those signals using machine learning techniques that can classify those gestures. During operation and after the camera 328 has detected movement by the user, detected tagged telemetry data may be provided to a machine learning gesture detection algorithm 352 as input. In an embodiment, the machine learning gesture detection algorithm 352 may classify this detected movement of the user to determine if a predetermined triggering gesture is being presented by the user. Where the machine learning gesture detection algorithm 352 determines that a triggering gesture has been detected, the output may be presented to the processor executing the extended reality switching system 350. In an embodiment, the machine learning gesture detection algorithm 352 may be executed at the information handling system 300 at a processor (e.g., 102, FIG. 1) and by the OS, in some embodiments, in whole or in part remotely on a server that includes computing resources, or via a processing device on the head-mounted display device 320. In one example embodiment, the machine learning gesture detection algorithm 352 may be remote from the information handling system 300 to be trained remotely. In an embodiment, the machine learning gesture detection algorithm operating at the processor and OS on the information handling system 300 may be a trained module sent to the information handling system 300 from these remote processing service (e.g., remote information management system 288, FIG. 2) after the machine learning gesture detection algorithm 352 had been trained. During operation and when the machine learning gesture detection algorithm 352 provides output indicating that a triggering gesture has been detected, this gesture data may be provided to the head mounted display CPU/GPU 332 for the head mounted display CPU/GPU 332 to execute a switching from a first type of extended reality to a second type of extended reality.

In an embodiment, the head-mounted display device 320 may be operatively coupled to one or more handheld controller 344. These handheld controllers 344 may allow a user of the head-mounted display device 320 to interact with virtual objects displayed to the user in the extended reality surrounding environment such as grab virtual objects or move virtual objects. As described herein, the head-mounted display device 320 may present to the user an extended reality environment that may be a VR environment, an MR environment, or an AR environment. The VR environment includes a complete virtual image presented to the user via the display device 340 of the head-mounted display device 320 and may provide no real-world images (e.g., images of the physical environment around the head-mounted display device 320) to the user concurrently via, for example, images obtained by a camera 328 on the head-mounted display device 320. The AR environment may include images of objects that are overlayed onto real world images presented to the user via the display device 340 of the head-mounted display device 320. The AR environment includes, in an embodiment, computer-generated perceptual information enhancing those real-world images (e.g., images of the physical environment around the head-mounted display device 320) presented to the user via the display device 340 of the head-mounted display device 320. In an embodiment, this computer-generated perceptual information may include multiple sensory modalities such as visual, auditory, haptic, somatosensory and even olfactory modalities. The AR simulation may, therefore, include a projection of real-world environment images (e.g., presented at the display device 340 of the head-mounted display device 320) with information or objects added virtually as an overlay. MR simulations may include a merging of real-world images (e.g., images of the physical environment around the head-mounted display device 320) captured by the camera and virtual, computer-generated images that are presented to the user. In an embodiment, unlike in AR, the user interacting in an MR simulation may interact with the digital-objects presented to the user. The handheld controller 344 may include one or more input buttons that allow the user to perform various functions while viewing an extended reality simulation. In an embodiment, the handheld controller 344 may communicate wirelessly with the head-mounted display device 320 using, for example, a Bluetooth connection or some other wireless protocol as described herein.

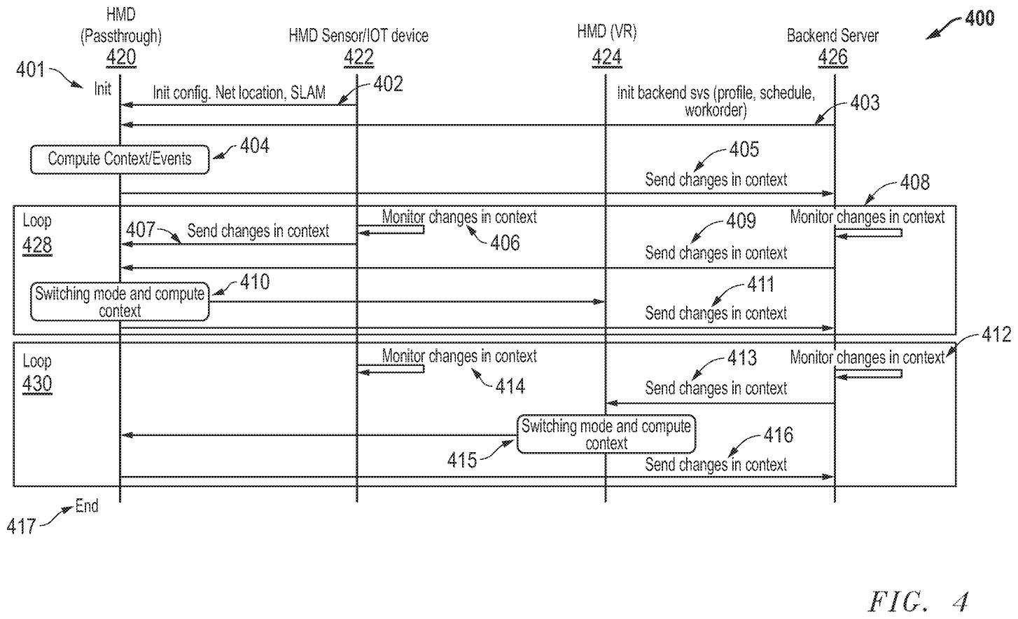

FIG. 4 is a process diagram illustrating a process executed by a head-mounted display (HIVID) device according to an embodiment of the present disclosure. As used herein, the HMD device (passthrough) 420 indicates a state where the HMD device is projecting to a user, real-world images provided via the camera and display device of the HMD device or that the user may partially view the surrounding physical environment. At this state, the user may be presented with, exclusively, real-world images in an embodiment. However, at HMD device (passthrough) 420 in this mode the user may also experience an AR simulation or MR simulation with extended reality images included based on the context of the use of the HMD device.

As used herein, the HMD sensor/IoT device 422 indicates a state of the one or more sensors of the HMD device and/or the arrangement or use of IoT devices used to determine the location of the HMD device. For example, an Internet-of-Things (IoT) device may include sensors that may be detectable by the head-mounted display device and provides data to the head-mounted display device that it is within a physical environment. This may include tags, transponders, or other location tags that can be used to triangulate the location of the head mounted display device within the physical environment. In this example embodiment, the location tags may send signals, wirelessly, to the head mounted display device using, for example, time of flight data to triangulate the location of the head mounted display device within the physical environment. Other sensors such as IR sensors and detectors, for example, either on the head mounted display device (e.g., inward-out location detection) or located within the physical environment (e.g., outward-in location detection), that is used to triangulate the location of the head mounted display device within the physical environment. As described herein, in order to project images within the headset such that those images are incorporated within the actual or virtual reality surrounding the headset, a head-mounted display device position engine may execute computer readable program code that determines the location of the head-mounted display device within an environment. In an embodiment, the head-mounted display device position engine may execute computer readable program code defining a simultaneous localization and mapping (SLAM) process. This SLAM process may be employed in order to identify the position of the headset with respect to its surrounding physical environment, model the surrounding physical environment as a relative extended reality environment for position and movement in the extended reality environment as viewed from the perspective of the headset wearer, and render the modeled image in a three-dimensional extended reality environment matching the surrounding real-world physical environment, among other tasks. Measurements of distances between the headset and landmarks or objects in its surrounding physical environment may be used in such SLAM processes to identify the position of the headset in its extended reality environment as related to a physical environment. It is appreciated that other types of processes may be implemented by the head-mounted display device position engine that may use data from one or more GPS sensors, accelerometers, and other position sensors. In another example, the head-mounted display device position engine may implement other location-based services (LBS) that define the position of the head-mounted display device. Thus, although the head-mounted display device position engine may be described herein as implementing a SLAM process, these other processes are also contemplated as alternative or additional processes used the define the positional location of the head-mounted display device. Communication with such external sensors or systems may be conducted via out of band (OOB) wireless communications in some embodiments.

As used herein, the HMD (VR) 424 is a state where the HMD device is presenting to a user a VR simulation. Again, VR simulations do not include any real-world images captures by the camera of the HMD device but instead overlays a virtual representation of the real world or a virtual world different from the real-world.

Additionally, as described herein, the backend server 426 may be similar to the remote data center 286 of FIG. 3. In an embodiment, the backend server 426 may include a remote information management system, a system center configuration manager, and a trained gesture detection algorithm that may be used to identify the user, provide access to user profiles, work schedule projects, remote assistance tasks, floor and environment maps of the environment (among other environments), and training videos among other data. The SCCM may push configuration policies to other manageability methods down the participating devices including the head-mounted display devices and any information handling systems associated, if at all, with the HMD device. These configuration policies may include device specific configuration policies and manageability methods and may include device identification data such that the SCCM may know which of the configuration policies to provide to the individual head-mounted display device. The trained gesture algorithm may be used, in an embodiment, to recognize a gesture from a user and cause an extended reality switching system to switch the HMD device from a first type of extend reality simulation to a second type of extended reality simulation as described herein. According to various embodiments herein, the communication with the backend server 426 with device specific configuration policies and management methods as well as communication of status and triggering events or context events for extended reality switching inputs may be conducted with the back-end server system out of band (OOB) wired or wireless communications in some embodiments to reduce the burden on the processors such as CPU, GPU or other processors in the head-mounted display device or the local, host information handling system.

The process flow 400 may include initializing the HMD device at 401 by, for example activating a power button located on the HMD device. The initialization may cause a basic input/output system (BIOS) or other initializing computer code or hardware to initialize an operating system of the HMD device. This initialization at 401 may cause the head mounted display CPU/GPU of the HMD device to determine the physical location and/or orientation of the HMD device within an environment. This process is described in an example embodiment here where the user is responsible for repairing a leak in a hydro-pump or other equipment. As the user puts on the HMD device on after arriving at the real-world location and powers up the HMD device at 401, a SLAM process described herein may be initiated at 402 that maps the physical environment and presents a digital image of the physical world to the user at the HMD device (passthrough) 420. The SLAM process, in an embodiment, may be augmented with other types of location detection systems. These additional location detection systems include, for example, positional sensors within the HMD device, Wi-Fi triangulation systems, IoT device systems among others as described herein. At this point, the HMD device may present to the user a security or authentication interface for the user to provide login data to access the functionalities of the HMD device as described herein. In an embodiment, these functionalities may include accessing, at 403, user profiles, work schedule projects, remote assistance tasks, floor and environment maps of the environment (among other environments), and training videos among other data at the backend server 426. In an embodiment, this data may be maintained off-site on a remote information management server maintained on the network. The HMD device may access this data via a wireless connection via radio and antenna within the HMD device. In an embodiment, the radio and antenna may operatively couple the HMD device to a remote server that maintains this data. In another embodiment, the HMD device may be operatively coupled to an information handling system (e.g., a laptop device) with the wireless interface adapter of the information handling system operatively coupled to a data storage device storing this user profiles, work schedule projects, remote assistance tasks, floor and environment maps of the environment (among other environments), and training videos among other data.

With access to this data at 403 and 402, the HMD device may determine the user operating the HMD device via the login credentials and access, for example, the user' profile and current work schedule projects at 403. This data may allow the HMD device to access environment-specific data based on the user's work schedule (e.g., indicating where the user is to be at any given time) and the projects to be addressed by the user. Following the example, the user's work schedule may indicate that the hydro-pump or other equipment at the indicated location is scheduled to be repaired by the user. Based on this additional information, the remote information management server may link the location with accessible floor and environment maps of the located physical environment images of the hydro pump or other equipment to be required, connection for power, water or other aspects including control and location (among other environments), and training videos related to the environment the user is at currently.

With this data, the head mounted display CPU/GPU of the HMD device may compute the context and events at 404 at the HMD device (passthrough) 420. A triggering event or context at this point may include movement, if any, of the user through the environment and/or initiation of the training session, for example. In an example embodiment, the user may be engaging with the head-mounted display device in order to complete a repair (e.g., repairing a hydro-pump or other equipment), engaging in a guided museum tour, initiating a conference call where virtual collaboration is requested via the head-mounted display device, initiating an application such as a gaming application or an art application, or consulting with a salesman virtually, among other tasks described and mentioned herein. Changes in context (e.g., extended reality switching input as triggering events) may be sent to the backend server at 405, such as via OOB communications in an embodiment, to initiate these processes and notify the backend server 405 of the activation and operation of the head-mounted display device throughout this process.

Because, in an example embodiment, the user's task may be to repair the hydro-pump or other equipment (data received at 403) and because the user requires additional training (data received at 403) in this example, the user may select a training session on a user display presented to the user on a display device of the HMD device. Alternatively, because the scheduling profile was accessed at 403, the HMD device (passthrough) 420 may automatically initiate the training session. This causes the process 400 to exit from loop 428 (e.g., HMD Passthrough) with user experiencing AR/MR) and enter loop 430 that describes the operations of the HMD device during a training session.

In an embodiment, at loop 428, the extended reality switching system may operate at the HMD (passthrough) status 420 and monitor changes in context of the AR or MR simulation from HMD sensors or external IoT device sensors at 406 sent at 407 to the HMD (passthrough) operation 420, or monitor changes in the AR or MR simulation context or other factors at 408 in the backend server 426 which are sent at 409. Such context changes may be communicated via OOB wireless or wired communications in an example embodiment. At 410, a triggering event may cause the AR simulation or MR simulation to end and the VR simulation context to be initiated at HMD (VR) 424 so that the user may train via virtual reality simulation. Such a triggering event may comprise an extended reality switching input to the extended reality switching system and cause a mode change (e.g., to HMD (VR) 424). The mode and context may also be send, such as via OOB communication, at 411 to the backend server 426. This triggering event at 410 may include, for example, the initiation of a training session by the user via the AR or MR simulation indicating that the user is ready to start being trained to repair the hydro-pump or other equipment. This triggering event at 410 may be used as extended reality switching input for the extended reality switching system to make the switch between the first ER simulation (e.g., AR or MR simulation) at loop 428 to a second ER simulation (e.g., VR simulation) at loop 430.

In an embodiment, this training session may be presented to the user as a VR training session that is fully immersive in the virtual world via HMD (VR) 424 status. This VR session, such as a VR training session, operates the extended reality switching system at loop 430 and includes continually monitoring for changes in context at 412 at the operating backend server 426 which are communicated at 413 to the HMD (VR) mode 424 as the user engages in the VR training. Loop 430 further includes continually monitoring for changes in context at 414 of the HMD sensors and external IoT devices 422 for position or other inputs which are communicated to the HMD (VR) mode 424 as the user engages in the VR training. Such context and sensor communications may be conducted via OOB communication in some embodiments. In an embodiment, the training session may also, based on the floor and environment maps as well as the real-time SLAM data received at 402, create a safety training boundary the user may train within in the current physical environment as related to the presented virtual environment. Because the training session is partially based on known floor and environment maps at and around the hydro-pump and known schematics of the hydro-pump or other equipment, the virtual world, in an example embodiment, may mimic the real-world environment. At this point the training session may begin within loop 428 and the user may be trained on not only how to repair a hydro-pump or other equipment, but also identify the hydro-pump or other equipment at its specific real-world location using the floor and environment maps and known schematics, equipment, or controls.

In an embodiment, any changes in the context at 412 may be sent at 413 the HMD device (VR) 424 so that the HMD device may present to the user updated images as the user progresses through the training session. Still further, any changes in the context at 414 (e.g.., HMD location changes via sensors and IoT data) may be sent the backend server 426 and back to the HMD (VR) 424 at 416 so that the HMD device may present to the user updated images within the virtual environment as the user progresses through the training session. This may serve to prevent the user from being placed in danger as the HMD (VR) 424 is conducting the VR session training. Still further, any changes in the context at 403 (e.g., schedule changes, user profile changes, or workorder changes) may be sent 413 to the HMD device (VR) 424 from monitoring at 412 so that the HMD device may present to the user updated images as the user progresses through the training session. For example, a manager may add a software updates to the workorder indicating that machine valve lubrication for certain equipment is to be added to the workorder and, potentially, additional training is provided in the HMD (VR) 424 session.

In an embodiment, at 415, the virtual reality simulation may end or reach a stage where a triggering event occurs which comprises an extended reality switching input and an AR or MR reality simulation may be started so that the user may continue with the repair work of the hydro-pump leak. The extended reality switching system may then enter loop 428 for an AR or MR simulation and this change in context may be sent via 416 to the back end server 426. Such communication of changes in context at 416 may be conducted via OOB communication in an embodiment. Again, the AR or MR simulation may present to the user images of the physical environment around the head-mounted display device with virtual/virtually manipulatable images overlayed onto these images of the physical environment. This causes the HMD device to be operated as an HMD device (passthrough) 420 according loop 428. The triggering event at 415 may be, for example, an indication from the head-mounted display device that the VR simulation is completed which may be relayed to the backend server 426 where the backend server 426 receives this triggering event as extended reality switching input. At this point the backend server 426, via execution of the extended reality switching system, causes the AR or MR simulation to be presented to the user as an HMD (passthrough) 420 as described herein.

The process 400 may include the computation of the context and monitoring for events at 410 to switch from an AR/MR simulation (e.g., HMD (Passthrough) 420) to a VR simulation (e.g., HMD (VR) 424) or at 415 to switch from a VR simulation (e.g., HMD (VR) 424) to an AR/MR simulation (e.g., HMD (Passthrough) 420) at any time as described above. This, again, includes determining where, within the training session, for example, the user has progressed, where the user has moved, if at all, and the presence of events. As described herein, a triggering event may include automatic events that are used as extended reality switching input by the extended reality switching system to automatically switch the HMD device from a first type of extended reality (e.g., VR, AR, MR) to a second type of extended reality. For example, during the training session, a triggering event may occur that automatically switches, at 415, the user's view from a VR simulation to one of an AR simulation or MR simulation so that a real-world image of the physical environment can be seen by the user (e.g., the hydro-pump and other accessories as well as other equipment). Other triggering events may also occur that switch, at 410, the view seen by the user back to a VR simulation for further clarification and training. In an embodiment, a triggering event at 410 may occur automatically at the end of the training session such that, at loop 428, the user is presented with an AR/MR simulation ((e.g., HMD (Passthrough) 420). Any changes to the type of extended reality, the events that occur, and the location of the user within an extended reality environment may be sent, at 411 or 416, from the backend server 426 or to the head-mounted display device in order to alter the type of extended reality presented to the user. This allows the backend server 426 to provide any additional computations (e.g., graphical computations), where needed, back to the HMD device during this training session.

In an embodiment, the process 400 may include continually monitoring for changes in context at 406 as the user engages in the repair work of the hydro-pump or other equipment using AR simulation or MR simulation. These changes may include, for example, changes in location of the HMD device within the physical environment using the HMD sensor/IoT devices 422. Still further, any changes in the context at 408 (e.g.., schedule changes, user profile changes, or workorder changes) may be sent the HMD (VR) 424 at 409 so that the HMD device may present to the user updated images as the user progresses through the repair work.

Additionally, as seen in FIG. 4 at 415, the extended reality switching system, after receiving the change in context at 413 from the backend server 426 may initiate an AR or MR simulation at the HMD device (passthrough) 420 under loop 428. In an embodiment, an AR simulation, may include overlaying virtual text or graphics over real world images captured by the cameras of the HMD device. In an embodiment, an MR simulation under loop 428, may also include overlaying virtual text or graphics over real world images captured by the cameras of the HMD device with that text or graphics being manipulatable by the user using, for example, a handheld controller. This may be beneficial in the context of a user repairing a hydro-pump leak because the user may eliminate or otherwise mark sequences of tasks being completed as the repair progresses.

Again, any changes in context at 411 or 416 may be sent to the backend server 426 where appropriate so that the backend server 426 may compute graphical data on behalf of the HMD device. This graphical data may be updated regularly and in real-time to provide the user with the best images of the real and augment or mixed simulations presented. At 410 or 415, a triggering event may occur when the user has indicated, in this example embodiment, that the repair work of the hydro-pump is completed. This triggering event may be a result of the user indicating that the repair work is completed. In an embodiment, the user may implement a handheld controller to make such an indication either via a dedicated “complete” icon presented to the user and actuated virtually or by the user marking off the last task in the repair process virtually.

In an embodiment, the triggering event may be the detection of a gesture by the user at 410 or 415. In an embodiment, the extended reality switching system may implement a gesture detection process to determine whether a user is intending to switch from a first type of extended reality to a second type of extended reality such as when the AR simulation or MR simulation is to be ended. The gesture detection process may include detecting a gesture by a user at 410 or 415 via the cameras and determining whether that gesture is a triggering gesture (e.g., a triggering event) used to switch from the first type of extended reality to the second type of extended reality. For example, a user may present, in front of the camera of HIVID device a predetermine hand gesture and the extended reality switching system may execute, at 410 or 415, or have executed a machine learning gesture detection algorithm used to detect a gesture of a user and provide output indicating whether the detected gesture is or is not the triggering gesture. In this embodiment, the operation of the camera or other sensing device may detect a user's gesture by detecting movement of the user's body parts such as, in this example, the user's hand. The camera and other sensors may be used to detect the vector movements of the user's hand and processes those signals using machine learning techniques that can classify those gestures. During operation and after the camera has detected movement by the user, detected tagged telemetry data may be provided to a machine learning gesture detection algorithm at the backend server 426, for example, as input. In an embodiment, the machine learning gesture detection algorithm may classify this detected movement of the user to determine if a predetermined triggering gesture is being presented by the user. Where the machine learning gesture detection algorithm determines that a triggering gesture has been detected, the output may be presented to the head mounted display CPU/GPU executing the extended reality switching system. Where the machine learning gesture detection algorithm provides output indicating that a triggering gesture has been detected, this gesture data may be provided to the head mounted display CPU/GPU for the head mounted display CPU/GPU to execute a switching from, in this example embodiment, an AR simulation or MR simulation to a HMD device (passthrough) 420 state where the real-world image is presented to the use without any overlays. The process 400 may end at 417 with the user deactivating the HMD device or removing it from the user's head.

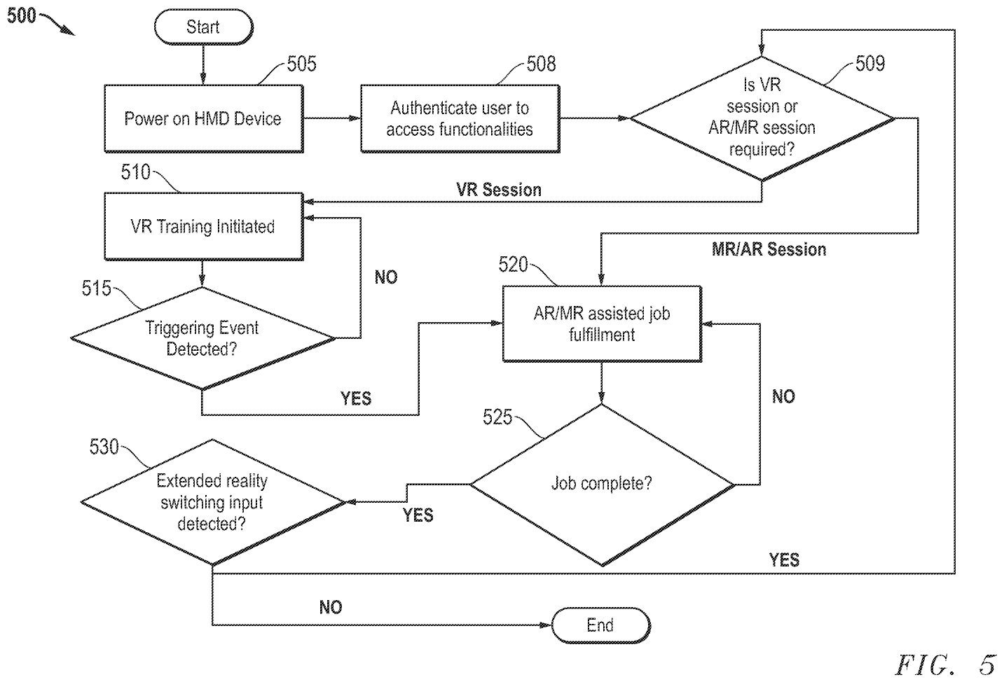

FIG. 5 is a flow diagram illustrating a method 500 implemented at a head-mounted display device operatively coupled to an information handling system according to an embodiment of the present disclosure. The method 500 may be executed by an HMD device operatively coupled to an information handling system similar to that described in connection with FIGS. 1, 2, and 3.

The method 500 may begin with the HMD device being powered on at block 505. This may cause a basic input/output system (BIOS) or other initializing computer code or hardware to initialize an operating system of the HMD device. This initialization at block 505 may also cause, in an embodiment, the head mounted display CPU/GPU of the HMD device to determine the physical location and/or orientation of the HMD device within an environment. In an embodiment, as the user puts on the HMD device on after arriving at the real-world location and powers up the HMD device at block 505, a SLAM process described herein may be initiated that maps the physical environment and presents a digital image of the physical world or relative to landmarks in the physical environment as a virtual environment to the user. The SLAM process, in an embodiment, may be augmented with other types of location detection systems. These additional location detection systems include, for example, positional sensors within the HMD device, Wi-Fi triangulation systems, IoT device systems among others as described herein.

In an embodiment, the HMD device may present to the user a security or authentication interface for the user to provide login data to access the functionalities of the HMD device and allow the user to be provided with authenticated access to the functionalities of the head-mounted display device at block 508 as described herein. In an embodiment, these functionalities may include accessing user profiles, work schedule projects, remote assistance tasks, floor and environment maps of the environment (among other environments), and training videos among other data at the backend server. In an embodiment, this data may be maintained off-site on a remote information management server maintained on the network. The HMD device may access this data via a wireless connection via a radio and antenna within the HMD device. In an embodiment, the radio and antenna may operatively couple the HMD device to a remote server that maintains this data. In another embodiment, the HMD device may be operatively coupled to an information handling system (e.g., a laptop device) with the wireless interface adapter of the information handling system operatively coupled to a data storage device storing this user profiles, work schedule projects, remote assistance tasks, floor and environment maps of the environment (among other environments), and training videos among other data.

In an embodiment, a backend server may indicate that one of a VR session or an AR/MR session is required per the authentication data associated with the user or a setting on the head-mounted display may be set for either a VR session or an AR/MR session. The head-mounted display device may receive a decision as to or determine whether the ER session is to be a VR session or an AR/MR session at block 509. Where the authentication data provided to the backend server by the head-mounted display device indicates or it is determined that a VR session is to be initiated (e.g., where the user needs training on the repair work of the hydro-pump or other equipment, a videoconference call requires a VR session, etc.), the method 500 may proceed to block 510 with initiating a VR session, such as a VR training session, in the example embodiment herein.

As described herein, the data received from the backend server may indicate that or it may be determined locally that the VR session, such as the VR training session, is to be initiated in an embodiment at 510. The data may indicate that other extended realities such as AR simulations or MR simulations may be initiated based on the tasks and schedule data received at the HMD device from the backend server, for example, in other embodiments. It is contemplated that any order may occur. Proceeding with the example embodiment presented at block 510, the training session may continue and a CPU/GPU or other processor of the HMD device may determine whether a triggering event has been detected at block 515 as the VR session proceeds. As described herein, this triggering event may be one of many types of triggering events. For example, a triggering event may be a detection of the activation or switching of a button on the HMD device or a handheld controller operatively coupled to the HMD device. In another example embodiment, the triggering event may be an automatic event within executing software applications such as an ending event or a completed stage of the VR training session presented to the user. The data associated with the graphical data of the VR training session may include, for example, a tag that automatically triggers the event. In yet another embodiment, the triggering event may include the actuation of a virtual icon presented to the user on the display device of the HMD device. In still another embodiment, the triggering event may be the detection of a gesture by a user using a camera of the HMD device as described herein. Where no triggering event is detected at block 515, the method 500 may return to block 510 to continue with the VR training session.

Where a triggering event is detected at block 515, the method 500 may continue to block 520 where the triggering event comprises an extended reality switching input to cause the extended reality switching system to switch to a second type of extended reality session. In an example embodiment, the extended reality switching system may switch to an AR/MR session so as to proceed to an assisted job fulfillment in an example embodiment. As described herein, the switching from a VR session simulation (e.g., VR training session) to an AR/MR session for an assisted job fulfillment includes the execution of an extended reality switching system to switch between the first extended reality session to a second type of extended reality session. The extended reality switching system may be, in an example embodiment, computer readable program code that, when executed by the head mounted display CPU/GPU or other processor, switches from a first type of extended reality (e.g., VR simulation, AR simulation, or MR simulation) to a second type of extended reality (e.g., VR simulation, AR simulation, or MR simulation) upon detection of extended reality switching input and set the head-mounted display device to provide either the immersive VR simulation environment or provide a pass-through of visibility to the surrounding physical environment or navigation in a representation of the surrounding physical environment as further supported with extended reality images of the AR or MR simulation. As described herein, the head-mounted display device may be capable of generating and presenting to a user any type of extended reality images including AR, VR, and MR, or any other type of extended reality provided by the head-mounted display device and contemplated to exist along a reality-virtuality continuum.

At block 520 the method 500 may continue until the AR/MR assisted job fulfillment is completed. As described herein, the extended reality switching system may continually monitor for triggering events that may cause the HMD device to switch from extended reality to extended reality in order to complete the job. At block 525, the method 500 includes determining whether the job is complete. Where the job is not completed at block 525, the method 500 continues to block 520 until it is determined that the job has been completed.

Where the job has been determined to be completed at block 525 the method 500 may continue with determining, at block 530, whether any other triggering event is detected that may comprise an extended reality switching input being detected and determined. For example, where additional tasks are to be completed at the environment at or around the hydro-pump or other equipment, additional triggering events according to various embodiments herein may be received as extended reality switching input and, in some embodiments, flow may return to block 509 to determine if new VR training may be initiated at block 510 or if a different MR/AR session is to be initiated at block 520. Again, because the head-mounted display device may be used for other purposes such as for a videoconference meeting, a solar panel installation consultation, a guided museum tour, among others, the triggering event may vary such that it may be used as extended reality switching input for the extended reality switching system to switch from the first type of extended reality to the second type of extended reality. Where no extended reality switching input has been detected at block 530 and all tasks or jobs are complete, such as the software utilizing extended reality has finished, or the head-mounted display device has been turned off or removed, the method 500 may end.

The blocks of the flow diagrams of FIGS. 4 and 5 or steps and aspects of the operation of the embodiments herein and discussed above need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. An information handling system operating a head-mounted display comprising:
a processor;
a memory;
a power management unit (PMU);
a head-mounted display device including:
a display device in the head-mounted display device to present to a user an extended reality image of a surrounding environment;
a processor to execute computer readable program code of an extended reality switching system to switch from a first type of extended reality to a second type of extended reality upon detection of an extended reality switching input that includes a contextual event-based switching input based on context data of an application executing on a remote information handling system operably coupled to the head-mounted display; and
a wireless communication device to receive the context data from a-the remote information management system, the context data including data updating the extended reality images corresponding to the second type of extended reality presented to the user based on the extended reality switching input triggering a switch.

2. The information handling system of claim 1 further comprising:
the context data including:
user profiles;
calendar scheduling data;
remote access projects; and
location structural layout.

3. The information handling system of claim 1 further comprising:
a user login prompt displayed to the user via the display device in the head-mounted display device to allow a user to log into and gain access to the remote information management system.

4. The information handling system of claim 1 further comprising:
a handheld controller to provide controller input to the head-mounted display device to interact with a visual representation presented to the user via the display device including to detect user input as the extended reality switching input to switch from the first type of extended reality to the second type of extended reality.

5. The information handling system of claim 1 further comprising:
the extended reality switching system including a camera sensor to detect user input to switch from the first type of extended reality to the second type of extended reality.

6. The information handling system of claim 1 further comprising:
a simultaneous localization and mapping (SLAM) engine to:
identify the position of the head-mounted display device with respect to a surrounding physical environment;
model the surrounding environment as viewed from the perspective of the user of the head-mounted display device; and
render an extended reality environment image relative to the model of the surrounding physical environment.

7. The information handling system of claim 1 wherein the first type of extended reality and the second type of extended reality includes one of:
virtual reality;
mixed reality; or
augmented reality.

8. The information handling system of claim 1, wherein the extended reality switching system executes computer readable program code to switch from the second type of extended reality to the first type of extended reality upon detection of a second extended reality switching input.

9. A method implemented at a head-mounted display device operatively coupled to an information handling system comprising:
with a head-mounted display device position engine:
identifying the position of the head-mounted display device with respect to a surrounding physical environment;
modeling the surrounding physical environment as viewed from the perspective of a user of the head-mounted display device; and
rendering an extended reality environment image based from the model of the surrounding physical environment;
with a display device of the head-mounted display device, presenting to a user an extended reality environment image; and
with an extended reality switching system, executing computer readable program code to switch from a first type of extended reality to a second type of extended reality upon detection of an extended reality switching input that includes a contextual event-based switching input based on context data of an application executing on the information handling system operably coupled to the head-mounted display.

10. The method implemented at a head-mounted display device of claim 9 further comprising:
with an out-of-band (OOB) communication device, receiving context data from a remote information management system, the context data including adaptively computed data updating the extended reality images presented to the user based on selection of a first type of extended reality or second type of extended reality.

11. The method implemented at a head-mounted display device of claim 10 further comprising:
the context data including:
user profiles;
calendar scheduling data;
remote access projects; and
location structural layout.

12. The method implemented at a head-mounted display device of claim 9 further comprising:
displaying a user login prompt to the user in the extended reality environment image via the display device to allow a user to log into and gain access to a remote information management system.

13. The method implemented at a head-mounted display device of claim 9 further comprising:
with a handheld controller, receiving controller input to the head-mounted display device to interact with the extended reality environment image presented to the user via the display device.

14. The method implemented at a head-mounted display device of claim 9 further comprising:
the extended reality switching system including a camera sensor to detect a user input gesture as extended reality switching input indicative of switching from the first type of extended reality to the second type of extended reality.

15. The method implemented at a head-mounted display device of claim 9, wherein the extended reality switching system executes computer readable program code to switch from the second type of extended reality to the first type of extended reality upon detection of a second extended reality switching input.

16. An extended reality head-mounted display device operatively coupled to a local information handling system comprising:
a processor;
a memory;
a power management unit (PMU);
a wireless interface adapter for communicating to a remote information management system to receive context data from a remote information management system;
a display device at the extended reality head-mounted display device to present to a user an extended reality environment image relative to a surrounding physical environment; and
the processor to execute computer readable program code of an extended reality switching system to switch from a first type of extended reality to a second type of extended reality upon detection of an extended reality switching input that includes a contextual event-based switching input based on context data of an application executing on the local information handling system operably coupled to the head-mounted display, wherein the context data includes updates to the extended reality environment image presented to the user via the display device based on the first type of extended reality or second type of extended reality depending on the received contextual data.

17. The extended reality head-mounted display device of claim 16 further comprising:
a handheld controller to receive controller input for the head-mounted display device to interact with the extended reality environment image presented to the user via the display device.

18. The extended reality head-mounted display device of claim 16 further comprising:
the extended reality switching system operatively coupled to a camera sensor to detect a gesture as the extended reality switching input to switch from the first type of extended reality to the second type of extended reality.

19. The extended reality head-mounted display device of claim 16, wherein the extended reality switching system executes computer readable program code to switch from the second type of extended reality to the first type of extended reality upon detection of a second extended reality switching input.

20. The extended reality head-mounted display device of claim 16 further comprising:
wherein the first type of extended reality includes mixed reality or augmented reality and the second type of extended reality includes virtual reality.
